(19) United States
(12) Patent Application Publication
(10) Pub. No.: US 2019/0005035 A1
(43) Pub. Date: Jan. 3, 2019

(54) INFORMATION SEARCH SYSTEM, INTELLECTUAL PROPERTY INFORMATION SEARCH SYSTEM, INFORMATION SEARCH METHOD, AND INTELLECTUAL PROPERTY INFORMATION SEARCH METHOD

(71) Applicant: Semiconductor Energy Laboratory Co., Ltd., Atsugi-shi (JP)

(72) Inventors: Shunpei YAMAZAKI, Setagaya (JP); Yuji IWAKI, Isehara (JP); Hajime KIMURA, Atsugi (JP); Yoshiaki OIKAWA, Atsugi (JP); Natsuko TAKASE, Atsugi (JP)

(21) Appl. No.: 15/988,546

(22) Filed: May 24, 2018

(30) Foreign Application Priority Data
May 31, 2017 (JP) 2017-107358

(51) Int. Cl. G06F 17/30; G06N 3/04; G06K 9/66; G06F 17/27

(52) U.S. Cl. CPC G06F 17/30011; G06F 17/2755; G06K 9/66; G06N 3/04

(57) ABSTRACT

An information search system or an intellectual property information search system that is capable of highly accurate information search is provided. The intellectual property information search system includes a processing unit. First data and first reference analysis data are input to the processing unit. The first data includes first intellectual property information. The first reference analysis data includes plural pieces of second intellectual property information. The processing unit is configured to search the first reference analysis data for data similar to the first data to generate second data. The processing unit is configured to output the second data. The second data includes a piece of the second intellectual property information similar to the first intellectual property information and information showing the degree of similarity of the piece of the second intellectual property information to the first intellectual property information.

### BACKGROUND OF THE INVENTION

### 1. Field of the Invention

One embodiment of the present invention relates to an information search system and an information search method. Another embodiment of the present invention relates to an intellectual property information search system and an intellectual property information search method.

Note that one embodiment of the present invention is not limited to the above technical field. Examples of the technical field of one embodiment of the present invention include a semiconductor device, a display device, a light-emitting device, a power storage device, a memory device, an electronic device, a lighting device, a method for driving any of them, and a method for manufacturing any of them.

### 2. Description of the Related Art

Prior art search before application for an invention can reveal if there is a relevant intellectual property right. Domestic or foreign patent documents, papers, and the like obtained through the prior art search are helpful in confirming the novelty and non-obviousness of the invention and determining whether to file the application. The prior art search can be used for various purposes, for example, for searching whether there is an intellectual property right relevant to a certain industrial product or a certain paper.

When a user enters a keyword into a patent document search system, the system will output patent documents containing the keyword, for example.

To conduct highly accurate prior art search with such a system, a user needs to have good search techniques; for example, a user should use a proper search keyword and have to pick up needed patent documents from many patent documents searched.

Use of artificial intelligence is under consideration for various applications. In particular, artificial neural networks are expected to provide computers having higher performance than conventional von Neumann computers. In recent years, a variety of studies on creation of neural networks with electronic circuits have been carried out.

For example, Patent Document 1 discloses an invention in which weight data necessary for computation with an artificial neural network is retained in a memory device including a transistor whose channel formation region contains an oxide semiconductor.

### REFERENCE

### Patent Document 1

### [Patent Document 1] United States Patent Application Publication No. 2016/0343452

### SUMMARY OF THE INVENTION

An object of one embodiment of the present invention is to provide an information search system or an intellectual property information search system that enables highly accurate information search. Another object of one embodiment of the present invention is to provide an information search method or an intellectual property information search method that enables highly accurate information search. Another object of one embodiment of the present invention is to achieve highly accurate information search, especially for intellectual property information, in an easy input method.

Note that the descriptions of these objects do not disturb the existence of other objects. One embodiment of the present invention does not necessarily achieve all the objects. Other objects will be derived from the description of the specification, the drawings, and the claims.

One embodiment of the present invention is an information search system including a processing unit. First data and first reference analysis data are input to the processing unit. The first data includes first information. The first reference analysis data includes plural pieces of second information. The processing unit is configured to search the first reference analysis data for data similar to the first data to generate second data. The processing unit is configured to output the second data. The second data includes a piece of the second information similar to the first information and third information showing the degree of similarity of the piece of the second information to the first information.

One embodiment of the present invention is an intellectual property information search system including a processing unit. First data and first reference analysis data are input to the processing unit. The first data includes first intellectual property information. The first reference analysis data includes plural pieces of second intellectual property information. The processing unit is configured to search the first reference analysis data for data similar to the first data to generate second data. The processing unit is configured to output the second data. The second data includes a piece of the second intellectual property information similar to the first intellectual property information and information showing the degree of similarity of the piece of the second intellectual property information to the first intellectual property information.

The first data may include text data. The first reference analysis data may include reference text analysis data. The processing unit may include a first text analysis unit, a second text analysis unit, and a third text analysis unit. The first text analysis unit is configured to perform morphological analysis of the text data to generate first text analysis data. The second text analysis unit is configured to calculate an appearance frequency of a word included in the text data with the use of the first text analysis data to generate second text analysis data. The third text analysis unit is configured to compare the second text analysis data with the reference text analysis data to generate at least part of the second data. The second text analysis unit may be configured to generate the second text analysis data with the use of a neural network. The second text analysis unit may include a neural network circuit.

The first data may include image data. The first reference analysis data may include reference image analysis data. The processing unit may include a first image analysis unit and a second image analysis unit. The first image analysis unit is configured to input the image data into a learning model to generate first image analysis data. The second image analysis unit is configured to generate at least part of the second data with the use of the first image analysis data and the reference image analysis data. The first image analysis unit may be configured to generate the first image analysis data with the use of a neural network. The first image analysis unit may include a neural network circuit.

The first data may include text data and image data. The first reference analysis data may include reference text analysis data and reference image analysis data. The processing unit may include a text analysis unit, an image analysis unit, a first analysis unit, and a second analysis unit. The first analysis unit is configured to divide the first data into the text data and the image data. The text data and the reference text analysis data are input to the text analysis unit. The text analysis unit is configured to search the reference text analysis data for data similar to the text data to generate text analysis data. The image data and the reference image analysis data are input to the image analysis unit. The image analysis unit is configured to search the reference image analysis data for data similar to the image data to generate image analysis data. The text analysis data and the image analysis data are input to the second analysis unit. The second analysis unit is configured to generate at least part of the second data with the use of the text analysis data and the image analysis data.

The information search system or the intellectual property information search system may further include a memory unit. The memory unit includes the first reference analysis data.

In addition, second reference analysis data may be input to the processing unit. The second reference analysis data includes plural pieces of third intellectual property information. One of the first reference analysis data and the second reference analysis data includes patent document information, and the other includes industrial product information. The processing unit is configured to search the second reference analysis data for data similar to the first data to generate third data. The processing unit is configured to output the third data. The third data includes a piece of the third intellectual property information similar to the first intellectual property information and information showing the degree of similarity of the piece of the third intellectual property information to the first intellectual property information.

For example, the first data may include technical information on an industrial product and launch date information on the industrial product. The second data may include information on a first patent document whose filing date is before the launch date of the industrial product.

For example, the first data may include information on a first patent document and filing date information on the first patent document. The second data may include information on a second patent document whose filing date is before the filing date of the first patent document. An applicant of the second patent document may be different from an applicant of the first patent document.

The information search system or the intellectual property information search system may further include an electronic device and a server. The electronic device includes a first communication unit. The server includes the processing unit and a second communication unit. The first communication unit is configured to supply the first data to the server through one or both of wire communication and wireless communication. The processing unit is configured to supply the second data to the second communication unit. The second communication unit is configured to supply the second data to the electronic device through one or both of the wire communication and the wireless communication.

The processing unit may include a transistor. The transistor may include a metal oxide in a channel formation region. Alternatively, the transistor may include silicon in the channel formation region.

One embodiment of the present invention is an information search method. The method includes the steps of: inputting first data including first information and first reference analysis data including plural pieces of second information, searching the first reference analysis data for data similar to the first data, generating second data including a piece of the second information similar to the first information and information showing the degree of similarity of the piece of the second information to the first information, and outputting the second data.

One embodiment of the present invention is an intellectual property information search method. The method includes the steps of: inputting first data including first intellectual property information and first reference analysis data including plural pieces of second intellectual property information, searching the first reference analysis data for data similar to the first data, generating second data including a piece of the second intellectual property information similar to the first intellectual property information and information showing the degree of similarity of the piece of the second intellectual property information to the first intellectual property information, and outputting the second data.

Text data included in the first data may be subjected to morphological analysis to generate first text analysis data. An appearance frequency of a word included in the text data may be calculated with the use of the first text analysis data to generate second text analysis data. The second text analysis data may be compared with reference text analysis data included in the first reference analysis data to generate at least part of the second data. The second text analysis data may be generated with the use of a neural network.

Image data included in the first data may be input to a learning model to generate first image analysis data. At least part of the second data may be generated with the use of the first image analysis data and reference image analysis data included in the first reference analysis data. The first image analysis data may be generated with the use of a neural network.

The first data may be divided into text data and image data. Reference text analysis data included in the first reference analysis data is searched for data similar to the text data to generate text analysis data. Reference image analysis data included in the first reference analysis data is searched for data similar to the image data to generate image analysis data. At least part of the second data may be generated with the use of the text analysis data and the image analysis data.

Second reference analysis data including plural pieces of third intellectual property information may be input, and the second reference analysis data may be searched for data similar to the first data. Third data including a piece of the third intellectual property information similar to the first intellectual property information and information showing the degree of similarity of the piece of the third intellectual property information to the first intellectual property may be generated and output.

According to one embodiment of the present invention, an information search system or an intellectual property information search system that enables highly accurate information search can be provided. According to one embodiment of the present invention, an information search method or an intellectual property information search method that enables highly accurate information search can be provided. According to one embodiment of the present invention, highly accurate information search, especially for intellectual property information, can be achieved in an easy input method.

Note that the description of these effects does not preclude the existence of other effects. One embodiment of the present invention does not necessarily have all the effects listed above. Other effects can be derived from the description of the specification, the drawings, and the claims.

### BRIEF DESCRIPTION OF THE DRAWINGS

FIG. 1 is a block diagram illustrating an example of an intellectual property information search system.

FIG. 2 is a flow chart illustrating an example of an intellectual property information search method.

FIGS. 3A and 3B are block diagrams illustrating an example of a processing unit.

FIG. 4 is a flow chart illustrating an example of a method for generating reference analysis data.

FIGS. 5A and 5B illustrate an example of a method for generating reference analysis data.

FIG. 6 is a flow chart illustrating an example of an intellectual property information search method.

FIGS. 7A to 7C illustrate an example of an intellectual property information search method.

FIGS. 8A and 8B are block diagrams illustrating an example of a processing unit.

FIG. 9 is a flow chart illustrating an example of a method for generating reference analysis data.

FIG. 10 illustrates an example of a method for generating reference analysis data.

FIG. 11 is a flow chart illustrating an example of an intellectual property information search method.

FIGS. 12A and 12B illustrate an example of an intellectual property information search method.

FIG. 13 is a block diagram illustrating an example of a processing unit.

FIG. 14 is a flow chart illustrating an example of an intellectual property information search method.

FIGS. 15A and 15B illustrate an example of an intellectual property information search method.

FIG. 16 is a block diagram illustrating an example of a processing unit.

FIG. 17 is a flow chart illustrating an example of an intellectual property information search method.

FIG. 18 is a block diagram illustrating an example of an intellectual property information search system.

FIGS. 19A and 19B illustrate a configuration example of a neural network.

FIG. 20 illustrates a configuration example of a semiconductor device.

FIG. 21 illustrates a configuration example of a memory cell.

FIG. 22 illustrates a configuration example of an offset circuit.

FIG. 23 is a timing chart.

### DETAILED DESCRIPTION OF THE INVENTION

Embodiments will be described in detail with reference to the drawings. Note that the present invention is not limited to the following description. It will be readily appreciated by those skilled in the art that modes and details of the present invention can be modified in various ways without departing from the spirit and scope of the present invention. Thus, the present invention should not be construed as being limited to the description in the following embodiments.

Note that in structures of the present invention described below, the same portions or portions having similar functions are denoted by the same reference numerals in different drawings, and a description thereof is not repeated. Further, the same hatching pattern is applied to portions having similar functions, and the portions are not especially denoted by reference numerals in some cases.

The positions, sizes, ranges, or the like of components illustrated in drawings do not reflect the actual positions, sizes, ranges, or the like in some cases for easy understanding. Therefore, the disclosed invention is not necessarily limited to the position, size, range, or the like disclosed in the drawings.

Note that the terms “film” and “layer” can be interchanged with each other depending on the case or circumstances. For example, the term “conductive layer” can be changed into the term “conductive film”; and the term “insulating film” can be changed into the term “insulating layer”.

### Embodiment 1

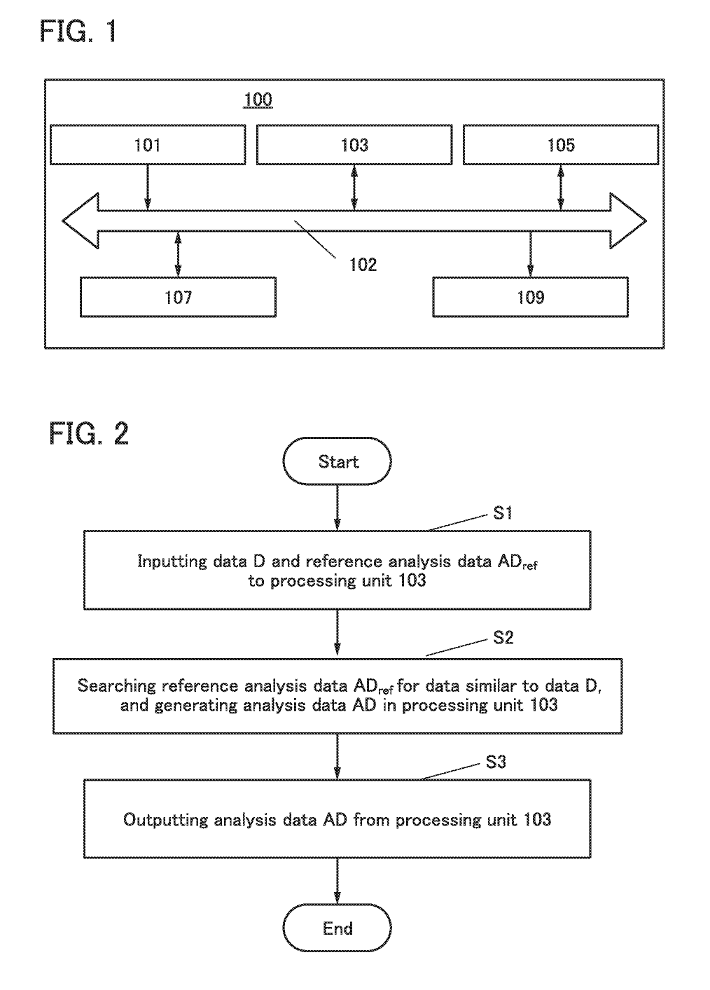

This embodiment describes an information search system of one embodiment of the present invention with reference to FIG. 1 to FIG. 18.

The information search system of one embodiment of the present invention includes a processing unit. First data (also referred to as input data) and reference analysis data are input to the processing unit. As the first data, data including target information (first information) which is searched for is input to the processing unit by a user of the system. The reference analysis data is data including plural pieces of information subjected to search. For example, the first information is an image and the reference analysis data includes a plurality of images.

The processing unit is configured to search the reference analysis data for data similar to the first data. The processing unit searches the plural pieces of information included in the reference analysis data for second information similar to the first information. For example, the second information is one or more images.

In addition, the processing unit is configured to generate second data (also referred to as output data). The second data includes the second information that is a search result. The second data further includes third information that shows the degree of similarity of the second information to the first information.

For example, the third information is expressed by a proportion, and output as a numerical value within 0 to 1, 0% to 100%, or the like (a larger value indicates a greater degree of similarity).

When the second information includes plural pieces of information (e.g., a plurality of images), the plural pieces of information can be listed and output in descending order of similarity to the first data by using the third information that shows the similarity. Information with similarity higher than a certain value can be output as the second information.

The information search system may be configured to output a difference between the first information and the second information.

The information search system preferably uses an artificial intelligence (AI) for at least part of processing to generate the second data.

In particular, the information search system preferably uses an artificial neural network (ANN; hereinafter just referred to as neural network in some cases) to generate the output data. The neural network is obtained with a circuit (hardware) or a program (software).

In this specification and the like, the neural network indicates a general model having the capability of solving problems, which is modeled on a biological neural network and determines a connection strength of neurons by learning. The neural network includes an input layer, a middle layer (hidden layer), and an output layer.

In the description of the neural network in this specification and the like, to determine a connection strength of neurons (also referred to as weight coefficient) from the existing information is called “leaning” in some cases.

In this specification and the like, to draw a new conclusion from the neural network formed with the connection strength obtained by the learning is called “inference” in some cases.

The neural network is executed by a huge number of product-sum operations. The use of one or both of a digital circuit and an analog circuit enables these operations. In the case of using a digital circuit, a large number of transistors are necessary, which is inefficient and requires high power consumption. Thus, the product-sum operations are preferably performed by an analog product-sum arithmetic circuit (hereinafter referred to as an analog product-sum circuit (APS)). The APS preferably includes an analog memory. The APS stores a weight coefficient obtained by learning in the analog memory, whereby it can perform the product-sum operations using analog data as it is. Consequently, the use of the APS enables efficient construction of a neural network with a small number of transistors.

In this specification and the like, an analog memory refers to a memory device that can store analog data. In this specification, analog data refers to data having a resolution of three bits (eight levels) or more. Multilevel data is referred to as analog data in some cases.

Examples of the analog memory include a multilevel flash memory, a resistive random access memory (ReRAM), a magnetroresistive random access memory (MRAM), and a memory using an OS transistor (OS memory).

In this specification and the like, a transistor including an oxide semiconductor or a metal oxide in its channel formation region is referred to as an oxide semiconductor transistor or an OS transistor. The channel formation region of an OS transistor preferably includes a metal oxide.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is called an oxide semiconductor in some cases. That is to say, a metal oxide that has at least one of an amplifying function, a rectifying function, and a switching function can be called a metal oxide semiconductor, or OS for short.

The metal oxide in the channel formation region preferably contains indium (In). The metal oxide in the channel formation region that contains indium increases the carrier mobility (electron mobility) of the OS transistor. The metal oxide in the channel formation region is preferably an oxide semiconductor containing an element M. The element M is preferably aluminum (Al), gallium (Ga), tin (Sn), or the like. Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements may be used in combination as the element M. The element M is an element having high bonding energy with oxygen, for example. The element M is an element whose bonding energy with oxygen is higher than that of indium, for example. The metal oxide in the channel formation region is preferably a metal oxide containing zinc (Zn). The metal oxide containing zinc is easily crystallized in some cases.

The metal oxide in the channel formation region is not limited to a metal oxide containing indium. The semiconductor layer may include, for example, a metal oxide that does not contain indium but contains at least one of zinc, gallium, and tin (e.g., zinc tin oxide or gallium tin oxide).

### <1. Intellectual Property Information Search System>

This embodiment describes an intellectual property information search system as an example of an information search system. The intellectual property information search system can be used in search for intellectual property information. The intellectual property information search system of this embodiment can search for various kinds of information by changing reference data.

### <1-1. Summary of Intellectual Property Information Search System>

FIG. 1 is a block diagram of an intellectual property information search system 100. The intellectual property information search system 100 includes at least a processing unit 103. The intellectual property information search system 100 shown in FIG. 1 further includes an input unit 101, a transmission path 102, a memory unit 105, a database 107, and an output unit 109.

### [Input Unit 101]

Information is supplied to the input unit 101 from the outside of the intellectual property information search system 100. The information supplied to the input unit 101 is supplied to the processing unit 103, the memory unit 105, or the database 107 through the transmission path 102.

### [Transmission Path 102]

The transmission path 102 is configured to convey information. The input unit 101, the processing unit 103, the memory unit 105, the database 107, and the output unit 109 can send and receive information through the transmission path 102.

### [Processing Unit 103]

The processing unit 103 is configured to perform an operation, inference, or the like with the use of information supplied from the input unit 101, the memory unit 105, the database 107, or the like. The processing unit 103 can supply an operation result, an inference result, or the like to the memory unit 105, the database 107, the output unit 109, or the like.

The processing unit 103 preferably includes a transistor whose channel formation region contains a metal oxide. The transistor has an extremely low off-state current; therefore, with the use of the transistor as a switch for retaining electric charge (data) which has flown into a capacitor serving as a memory element, a long data retention period is feasible. When at least one of a register and a cache memory included in the processing unit 103 has such a feature, the processing unit 103 can be operated only when needed, and otherwise can be off while information processed immediately before switch-off is stored in the memory element; accordingly, normally-off computing is possible and the power consumption of the intellectual property information search system can be reduced.

The processing unit 103 includes, for example, an operation circuit, a central processing unit (CPU), or the like.

The processing unit 103 may include a microprocessor such as a digital signal processor (DSP) or a graphics processing unit (GPU). The microprocessor may be configured with a programmable logic device (PLD) such as a field programmable gate array (FPGA) or a field programmable analog array (FPAA). With the processor, the processing unit 103 can interpret and execute instructions from programs to process various kinds of data and control programs. The programs to be executed by the processor are stored in at least one of a memory region of the processor or the memory unit 105.

The processing unit 103 may include a main memory. The main memory includes at least one of a volatile memory such as a random access memory (RAM) and a nonvolatile memory such as a read-only memory (ROM).

For example, a dynamic random access memory (DRAM) or a static random access memory (SRAM) is used as the RAM, in which case a virtual memory space is assigned to the RAM to be used as a work space for the processing unit 103. An operating system, an application program, a program module, program data, a look-up table, and the like which are stored in the memory unit 105 are loaded into the RAM and executed. The data, program, and program module which are loaded into the RAM are each directly accessed and operated by the processing unit 103.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

### [Memory Unit 105]

The memory unit 105 is configured to store a program to be executed by the processing unit 103. The memory unit 105 may be configured to store an operation result and an inference result generated by the processing unit 103, information input to the input unit 101, and the like.

The memory unit 105 includes at least one of a volatile memory and a nonvolatile memory. For example, the memory unit 105 may include a volatile memory such as a DRAM or an SRAM. For example, the memory unit 105 may include a nonvolatile memory such as a resistive random access memory (ReRAM), a phase change random access memory (PRAM), a ferroelectric random access memory (FeRAM), or a magnetoresistive random access memory (MRAM), or a flash memory. In some cases, the memory unit 105 may include a storage media drive such as a hard disk drive (HDD) or a solid state drive (SSD).

### [Database 107]

The database 107 is configured to store reference analysis data. The database 107 may be configured to store an operation result and an inference result generated by the processing unit 103, information input to the input unit 101, and the like. The memory unit 105 and the database 107 are not necessarily separated from each other. For example, the intellectual property information search system may include a storage unit that has both the function of the memory unit 105 and that of the database 107.

### [Output Unit 109]

The output unit 109 is configured to supply information to the outside of the intellectual property information search system 100. For example, an operation result, an inference result, or the like in the processing unit 103 can be supplied to the outside.

### <1-2. Summary of Intellectual Property Information Search Method>

FIG. 2 is a flow chart of an intellectual property information search method in which the intellectual property information search system 100 is used.

In the intellectual property information search method of this embodiment, plural pieces of intellectual property information are prepared beforehand; when information on a certain intellectual property is entered, the prepared plural pieces of information can be searched for information similar to the entered information.

### [Step S1]

First, data D and reference analysis data AD_{ref} are input to the processing unit 103.

The data D is input to the input unit 101 from the outside of the intellectual property information search system 100. Then, the data D is supplied from the input unit 101 to the processing unit 103 through the transmission path 102. In some cases, the data D may be stored in the memory unit 105 or the database 107 through the transmission path 102 and supplied from the memory unit 105 or the database 107 to the processing unit 103 through the transmission path 102.

The reference analysis data AD_{ref} is supplied from the memory unit 105 or the database 107 to the processing unit 103 through the transmission path 102.

The data D includes first intellectual property information, and the reference analysis data AD_{ref} includes plural pieces of intellectual property information. The data D and the reference analysis data AD_{ref} each include one or both of text data and image data.

Intellectual property information is, for example, texts and drawings for describing an intellectual property; specific examples are publications such as a patent document (a patent application publication, a patent publication, or the like), a utility model publication, a design publication, a paper, and the like. Not only publications issued domestically but also those issued in foreign countries can be used as intellectual property information. These are suitable for both the data D and the reference analysis data AD_{ref}.

Each of the specification, claims, summary, and drawings of a patent document can be partly or wholly used as the data D or the reference analysis data AD_{ref}. For example, an embodiment for carrying out a certain invention, an example, a claim, or a drawing can be used as the data D or the reference analysis data AD_{ref}. Similarly, the text and drawings in another kind of publication such as a paper can be partly or wholly used as the data D or the reference analysis data AD_{ref}.

The intellectual property information is not limited to publications. For example, various files such as a document file and an image file possessed by a user or a user group of the intellectual property information search system can also be used as the data D or the reference analysis data AD_{ref}.

The intellectual property information can be texts and drawings for describing an invention, a device, or a design, information on an industrial product, or the like. These are suitable for both the data D and the reference analysis data AD_{ref}.

The data D can include, for example, texts and drawings for describing an invention, a device, or a design that is before application; technical thought; technical information; and information on an industrial product that is before sale.

The reference analysis data AD_{ref} can include, for example, patent documents of a certain applicant or patent documents in a certain technical field.

The data D and the reference analysis data AD_{ref} can include not only the content of an intellectual property itself but also various kinds of information relating to the intellectual property (e.g., bibliographic information). For example, when an intellectual property is in the form of a patent document, information on the applicant, technical field, application number, publication number, current status (pending, patented, abandoned, or the like), or the like can be included.

The data D and the reference analysis data AD_{ref} preferably include the date information of an intellectual property. In case where the intellectual property is in the form of a patent document, the date information can include, for example, the filing date, publication date, issue date, or the like; in case where the intellectual property is information on an industrial product, the date information can include, for example, the launch date.

In this way, the data D and the reference analysis data AD_{ref} can include various kinds of information on intellectual properties, so that various search scopes are selectable in the intellectual property information search system.

For example, a patent document, a paper, or an industrial product that is similar to an invention before filing can be searched for with the intellectual property information search system of this embodiment. Thus, prior art relating to the invention before filing can be searched for. Knowing and reviewing relevant prior art strengthens the invention, leading to a strong patent that other companies are highly likely to infringe.

For example, a patent document, a paper, or an industrial product that is similar to an industrial product before sale can be searched for with the intellectual property information search system of this embodiment. When the reference analysis data AD_{ref} includes one's own patent documents, the one can confirm whether patent applications are appropriately filed in association with technologies for the one's own industrial product before sale. When the reference analysis data AD_{ref} includes information on intellectual properties of others, the one can confirm whether or not the one's own industrial product before sale infringes the others' intellectual property right. Knowing and reviewing relevant prior art leads to discovery of a novel invention that is to be a strong patent contributing to one's own business. Search for an industrial product after sale may be conducted as well as search for an industrial product before sale.

For example, a patent document, a paper, or an industrial product that is similar to a certain patent can be searched for with the intellectual property information search system of this embodiment. In particular, search based on the filing date of the certain patent can reveal easily and accurately whether or not the patent includes grounds for invalidation.

### [Step S2]

Next, the processing unit 103 searches the reference analysis data AD_{ref} for data similar to the data D to generate analysis data AD.

The analysis data AD includes second intellectual property information similar to the first intellectual property information and information showing the degree of similarity of the second intellectual property information to the first intellectual property information. The second intellectual property information, similar to the first intellectual property information, is obtained in the search through the reference analysis data AD_{ref}.

A specific method for generating the analysis data AD is described later.

### [Step S3]

Next, the analysis data AD is output from the processing unit 103. The analysis data AD is supplied to the output unit 109 through the transmission path 102. In some cases, the analysis data AD may be stored in the memory unit 105 or the database 107 through the transmission path 102 and supplied from the memory unit 105 or the database 107 to the output unit 109 through the transmission path 102.

In this manner, search for intellectual property information can be conducted.

### <2. Analysis>

The specific method for generating the analysis data AD is described. First, text analysis and image analysis are described. Then, generation of the analysis data AD through both the text analysis and the image analysis is described. After that, generation of the analysis data AD through searching two or more kinds of intellectual property information for one piece of intellectual property information is described.

### <2-1. Text Analysis>

The intellectual property information search system of one embodiment of the present invention can perform text mining. Thus, a user of the intellectual property information search system does not need to choose a keyword or a phrase for search and can directly enter large-volume text data into the intellectual property information search system. Since choice of an appropriate search keyword is unnecessary, a difference in search accuracy among individuals can be reduced and accurate information search can be achieved.

In the text mining, text data is divided with the use of natural language processing. For example, nouns can be extracted through morphological analysis. In addition, syntax analysis, semantic analysis, context analysis, or the like may be conducted.

Other examples of the natural language processing include N-gram processing, term frequency-inverse document frequency (TF-IDF) processing, and the like.

Next, data mining is conducted for analysis. For example, association analysis, cluster analysis, or the like is performed. For the data mining, the above-mentioned neural network can be used. A recurrent neural network (RNN) is suitable because the RNN can deal with variable-length data such as text data. Long short-term memory (LSTM) or the like is also suitable.

As well as Japanese text, texts in various languages (e.g., English, Chinese, and Korean) can be analyzed. Various text analysis methods can be used depending on languages.

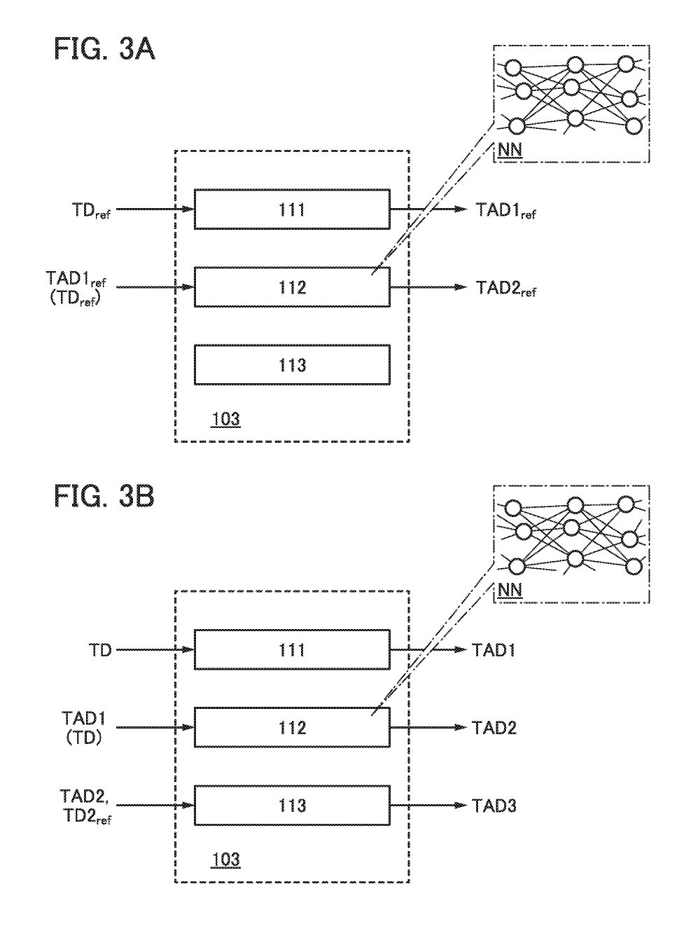

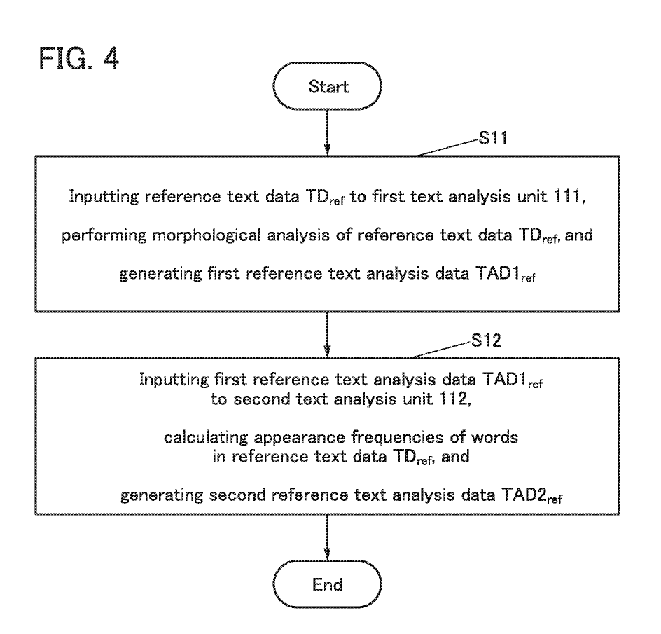

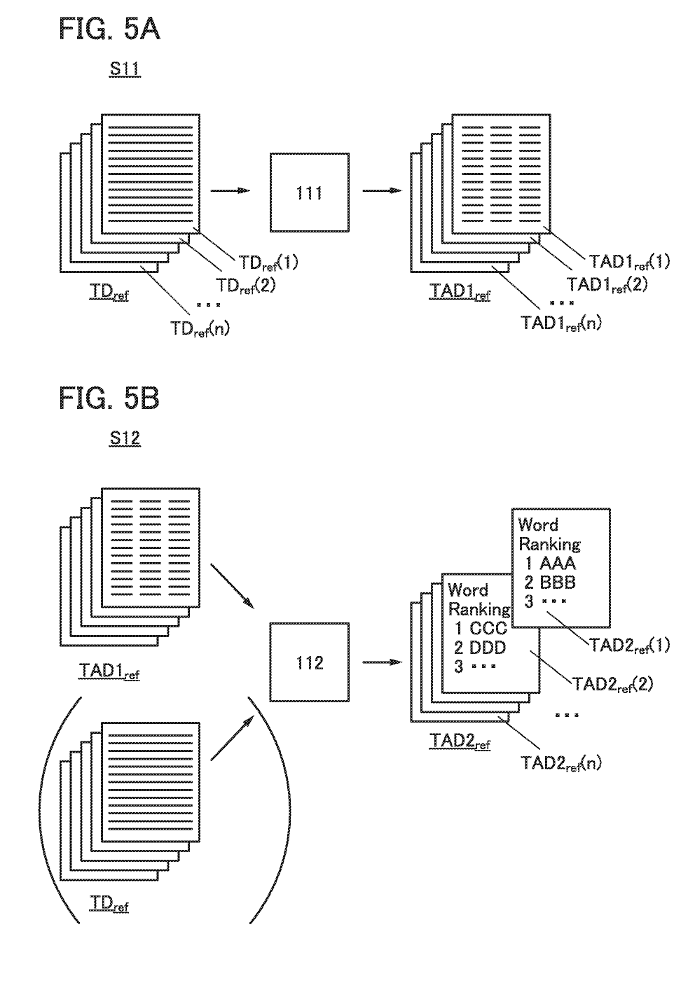

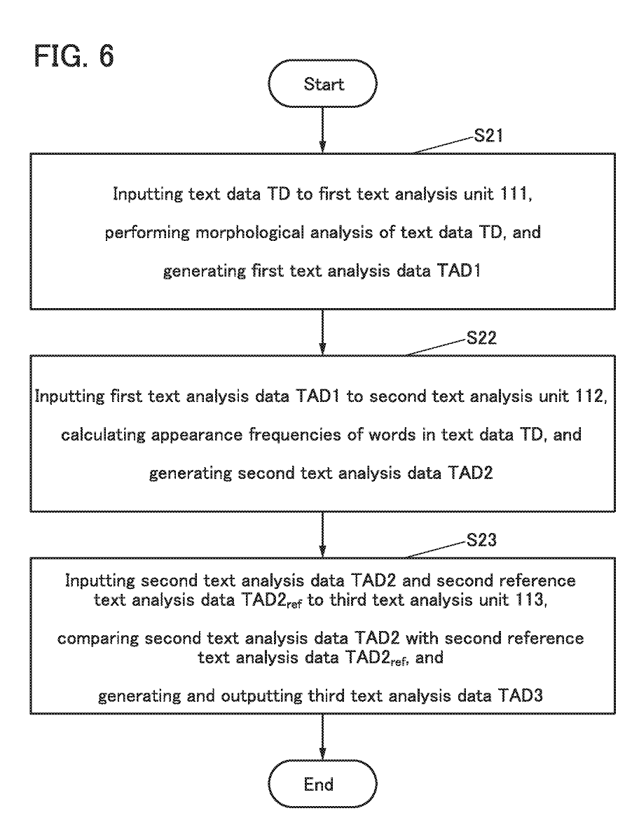

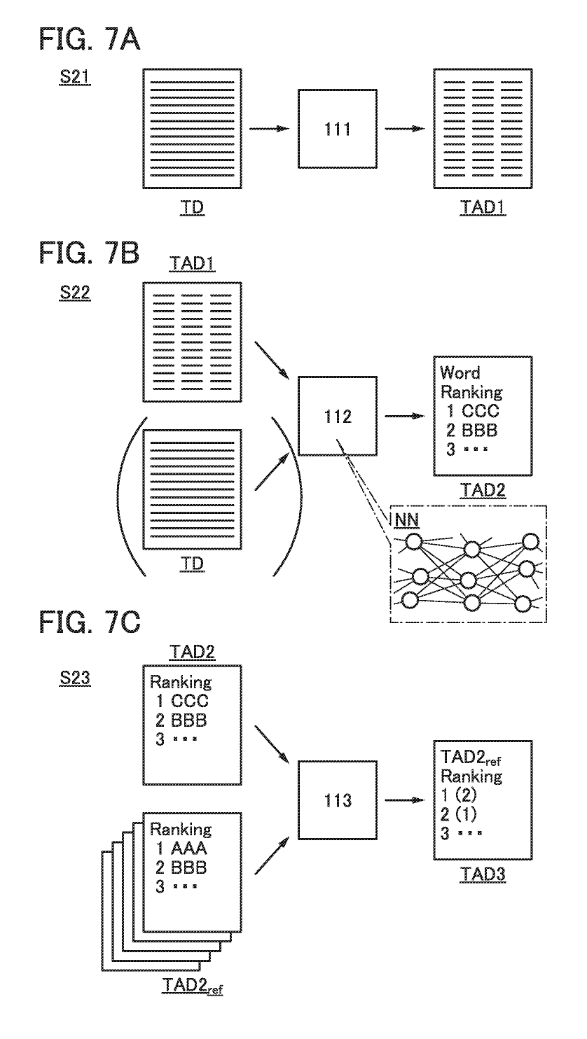

Text search with the intellectual property information search system 100 is described below with reference to FIGS. 3A and 3B, FIG. 4, FIGS. 5A and 5B, FIG. 6, and FIGS. 7A to 7C. FIGS. 3A and 3B show a configuration of the processing unit 103 that is capable of text search. FIG. 4 is a flow chart of processing for generating reference analysis data. FIGS. 5A and 5B are schematic views illustrating the steps in FIG. 4. FIG. 6 is a flow chart of processing for generating analysis data. FIGS. 7A to 7C are schematic views illustrating the steps in FIG. 6.

First, the processing for generating the reference analysis data is described with reference to FIG. 3A, FIG. 4, and FIGS. 5A and 5B. The reference analysis data is prepared in advance through this processing, and accordingly search for intellectual property information can be conducted with the intellectual property information search system 100.

### [Step S11]

Reference text data TD_{ref} is input to a first text analysis unit 111 and subjected to morphological analysis, so that first reference text analysis data TAD1_{ref} is generated.

The reference text data TD_{ref} is data through which the intellectual property information search system 100 searches. Data used as the reference text data TD_{ref} can be chosen as appropriate depending on usage of the intellectual property information search system 100.

The reference text data TD_{ref} is input to the processing unit 103 (the first text analysis unit 111 thereof) from the database 107 through the transmission path 102, for example.

FIG. 3A shows an example where the generated first reference text analysis data TAD1_{ref} is output to the outside of the processing unit 103. For example, the first text analysis unit 111 can output the first reference text analysis data TAD1_{ref} to the memory unit 105 or the database 107. In some cases, the first reference text analysis data TAD1_{ref} may be directly supplied to a second text analysis unit 112 from the first text analysis unit 111.

As shown in FIG. 5A, the reference text data TD_{ref} includes a plurality of text data. FIG. 5A shows n text data (n is an integer greater than or equal to 2), each of which is denoted as data TD_{ref}(x) (x is an integer greater than or equal to 1 and less than or equal to n).

The first text analysis unit 111 performs morphological analysis on each of the n text data and generates n reference text analysis data, each of which is denoted as data TAD1_{ref}(x) (x is an integer greater than or equal to 1 and less than or equal to n). For example, the data TD_{ref}(n) is subjected to the morphological analysis to generate the data TAD1_{ref}(n).

In the example of FIG. 5A, the input data TD_{ref}(1) includes a long sentence; in the output data TAD1_{ref}(1), the sentence is separated into a plurality of words.

[step S12]

Then, the first reference text analysis data TAD1_{ref} is input to the second text analysis unit 112, appearance frequencies of words in the reference text data TD_{ref} are calculated, and second reference text analysis data TAD2_{ref} is generated. Then, the second reference text analysis data TAD2_{ref} is output.

The second text analysis unit 112 preferably performs processing with a neural network NN. This leads to heightened search accuracy.

FIG. 3A shows an example where the generated second reference text analysis data TAD2_{ref} is output to the outside of the processing unit 103. For example, the second text analysis unit 112 can output the second reference text analysis data TAD2_{ref} to the memory unit 105 or the database 107. In some cases, the second reference text analysis data TAD2_{ref} may be directly supplied to a third text analysis unit 113 from the second text analysis unit 112.

As shown in FIG. 3A and FIG. 5B, not only the first reference text analysis data TAD1_{ref} but also the reference text data TD_{ref} can be input to the second text analysis unit 112. In some cases, a word included in the first reference text analysis data TAD1_{ref} may be vectorized. In this way, data suitable for processing in the second text analysis unit 112 may be input to the second text analysis unit 112.

Dictionary data may be input to the second text analysis unit 112. The dictionary data includes, for example, information on one or both of words whose appearance frequencies are calculated in the second text analysis unit 112 and words whose appearance frequencies are not calculated. This enables removal of noise and an improvement in search accuracy.

In the second text analysis unit 112, appearance frequencies of words are calculated for each of the n text data, and n reference text analysis data are generated. For example, appearance frequencies of words that are included in the data TD_{ref}(n) are calculated with the use of the data TAD1_{ref}(n) to generate data TAD2_{ref}(n).

In the example of FIG. 5B, the data TAD2_{ref}(1) shows that the most frequently used word and the second most frequently used word in the data TD_{ref}(1) are “AAA” and “BBB”, respectively. The data TAD2_{ref}(2) shows that the most frequently used word and the second most frequently used word in the data TD_{ref}(2) are “CCC” and “DDD”, respectively. FIG. 5B shows an example where words are listed in the descending order of appearance frequency, but the order is not limited thereto.

In this manner, the reference analysis data can be generated.

Next, the processing for generating the analysis data is described with reference to FIG. 3B, FIG. 6, and FIGS. 7A to 7C. Intellectual property information can be searched for with the use of the reference analysis data generated beforehand.

### [Step S21]

Text data TD is input to the first text analysis unit 111 and subjected to morphological analysis, so that first text analysis data TAD1 is generated.

For example, the text data TD is input to the processing unit 103 (the first text analysis unit 111 thereof) from the outside of the intellectual property information search system 100 through the input unit 101 and the transmission path 102.

FIG. 3B shows an example where the generated first text analysis data TAD1 is output to the outside of the processing unit 103. For example, the first text analysis unit 111 can output the first text analysis data TAD1 to the memory unit 105 or the database 107. In some cases, the first text analysis data TAD1 may be directly supplied to the second text analysis unit 112 from the first text analysis unit 111.

As shown in FIG. 7A, morphological analysis of the text data TD is performed in the first text analysis unit 111 to generate the first text analysis data TAD1. A long sentence included in the text data TD is separated into a plurality of words in the first text analysis data TAD1.

### [Step S22]

Then, the first text analysis data TAD1 is input to the second text analysis unit 112 and appearance frequencies of words in the text data TD are calculated, so that second text analysis data TAD2 is generated.

The second text analysis unit 112 preferably performs processing with the neural network NN. This leads to heightened search accuracy.

FIG. 3B shows an example where the generated second text analysis data TAD2 is output to the outside of the processing unit 103. For example, the second text analysis unit 112 can output the second text analysis data TAD2 to the memory unit 105 or the database 107. In some cases, the second text analysis data TAD2 may be directly supplied to the third text analysis unit 113 from the first text analysis unit 111.

As shown in FIG. 3B and FIG. 7B, not only the first text analysis data TAD1 but also the text data TD can be input to the second text analysis unit 112. In some cases, a word included in the first text analysis data TAD1 may be vectorized. In this way, data suitable for processing in the second text analysis unit 112 may be input to the second text analysis unit 112.

Dictionary data may be input to the second text analysis unit 112. The dictionary data includes, for example, information on one or both of words whose appearance frequencies are calculated in the second text analysis unit 112 and words whose appearance frequencies are not calculated. This enables removal of noise and an improvement in search accuracy.

The second text analysis unit 112 calculates appearance frequencies of words included in the text data TD with the use of the first text analysis data TAD1 to generate the second text analysis data TAD2.

As shown in FIG. 7B, the second text analysis data TAD2 shows that the most frequently used word and the second most frequently used word in the text data TD are “CCC” and “BBB”, respectively. FIG. 7B shows an example where words are listed in the descending order of appearance frequency, but the order is not limited thereto.

### [Step S23]

Next, the second text analysis data TAD2 and the second reference text analysis data TAD2_{ref} are input to the third text analysis unit 113 and compared with each other to generate third text analysis data TAD3. Then, the third text analysis data TAD3 is output.

FIG. 3B shows an example where the generated third text analysis data TAD3 is output to the outside of the processing unit 103. For example, the third text analysis unit 113 can output the third text analysis data TAD3 to the memory unit 105 or the database 107.

The third text analysis unit 113 searches the n data included in the second reference text analysis data TAD2_{ref} for data similar to the second text analysis data TAD2.

In the third text analysis unit 113, information showing the degree of similarity of each of the n data to the second text analysis data TAD2 can be obtained. With the obtained information, the data can be listed in the descending order of similarity as shown in FIG. 7C, for example. With the obtained information, only data whose similarity is higher than a predetermined value can be output.

In the example of FIG. 7C, the third text analysis data TAD3 shows that data that are the most and the second most similar to the second text analysis data TAD2 in the n data of the second reference text analysis data TAD2_{ref} are the data TAD2_{ref}(2) and the data TAD2_{ref}(1), respectively.

The third text analysis data TAD3 is part or all of the analysis data AD output from the processing unit 103. Note that the analysis data AD may be generated by combining the third text analysis data TAD3 with other data.

In this manner, data similar to the text data TD can be searched for with the intellectual property information search system 100. In the above example, the data TD_{ref}(2) is the most similar to the text data TD.

### <2-2. Image Analysis>

The intellectual property information search system of one embodiment of the present invention can perform image recognition. Thus, a user of the intellectual property information search system does not need to prepare a keyword, a text, or the like for search and can directly enter image data into the system to obtain desired information.

For search using an image, a convolutional neural network (CNN) is suitable. In particular, deep learning with the CNN is preferably used.

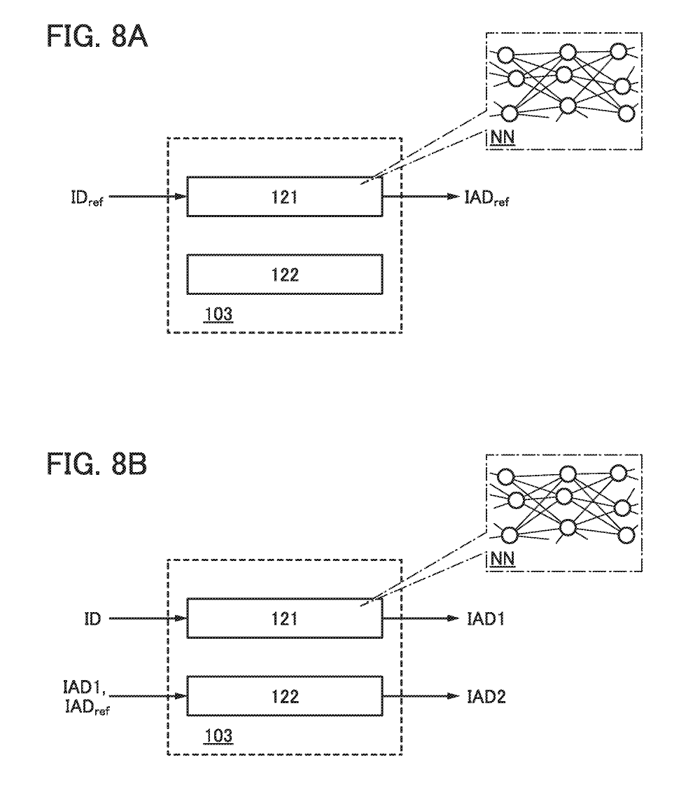

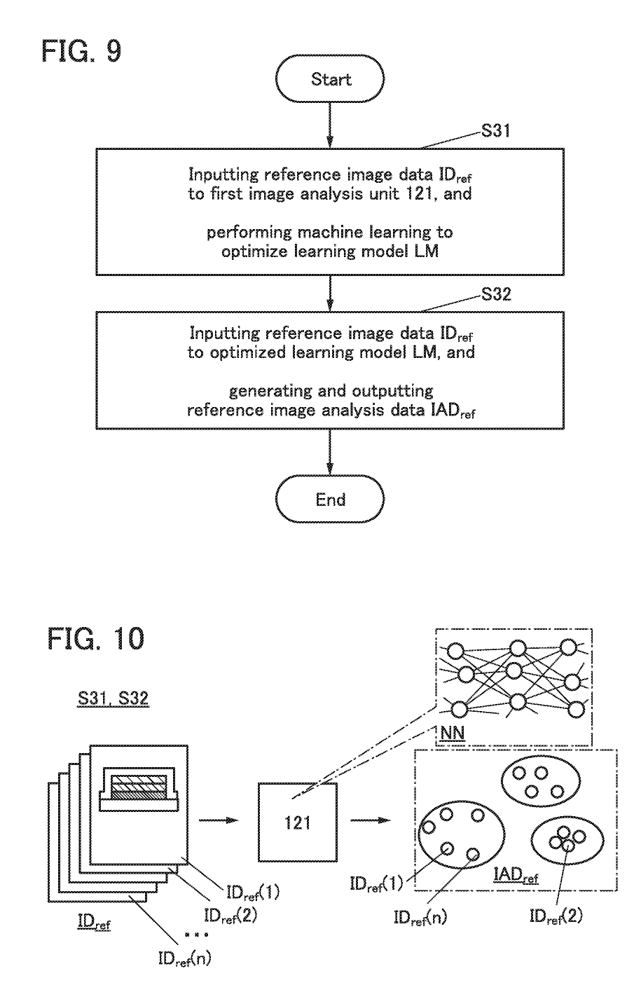

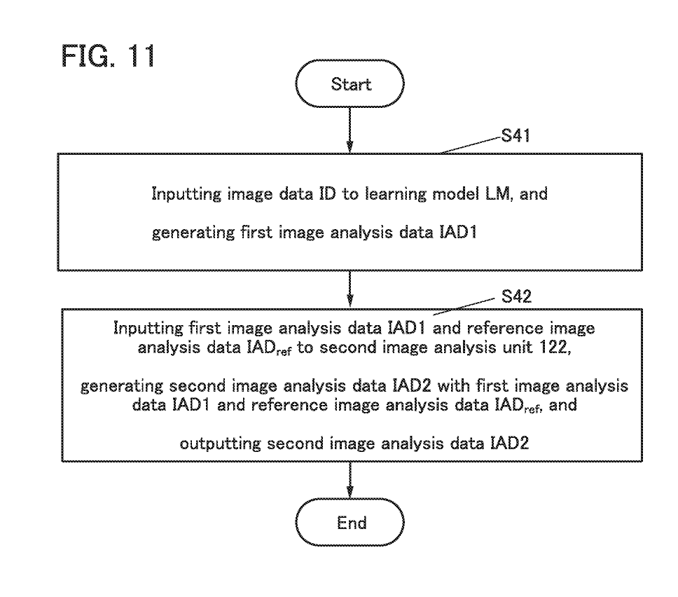

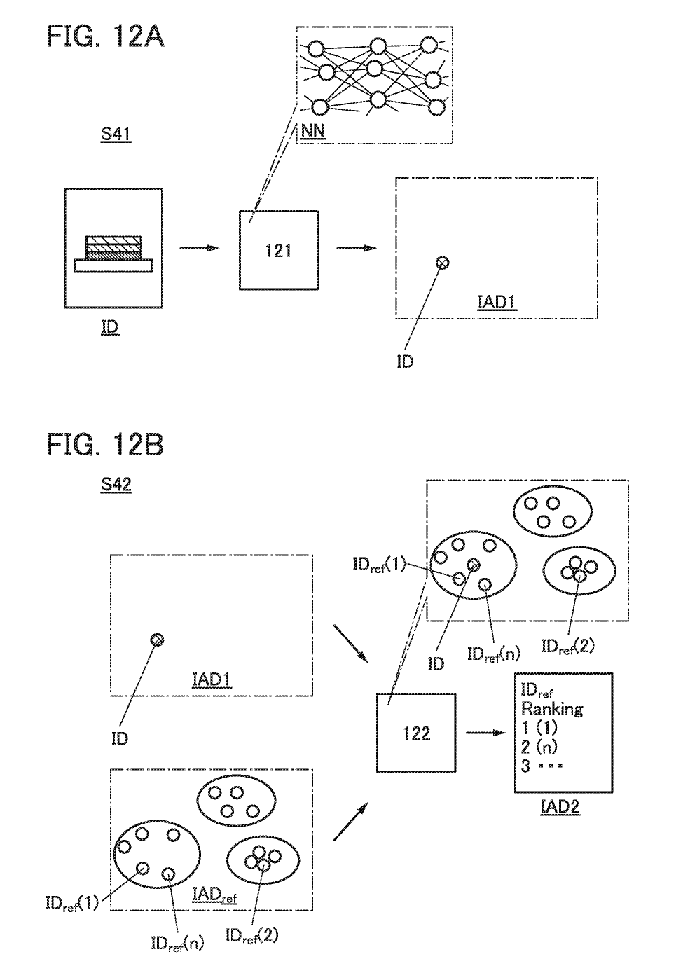

Image search with the intellectual property information search system 100 is described below with reference to FIGS. 8A and 8B, FIG. 9, FIG. 10, FIG. 11, and FIGS. 12A and 12B. FIGS. 8A and 8B show a configuration of the processing unit 103 that is capable of image search. FIG. 9 is a flow chart of processing for generating reference analysis data. FIG. 10 is a schematic view illustrating the steps in FIG. 9. FIG. 11 is a flow chart of processing for generating analysis data. FIGS. 12A and 12B are schematic views illustrating the steps in FIG. 11.

First, the processing for generating the reference analysis data is described with reference to FIG. 8A, FIG. 9, and FIG. 10. The reference analysis data is prepared in advance through this processing, and accordingly search for intellectual property information can be conducted with the intellectual property information search system 100.

### [Step S31]

Reference image data ID_{ref} is input to a first image analysis unit 121 and machine learning is performed so that a learning model LM is optimized.

The reference image data ID_{ref} is data through which the intellectual property information search system 100 searches. Data used as the reference image data ID_{ref} can be chosen as appropriate depending on usage of the intellectual property information search system 100.

The reference image data ID_{ref} is input to the processing unit 103 (the first image analysis unit 121 thereof) from the database 107 through the transmission path 102, for example.

The first image analysis unit 121 preferably performs processing with a neural network NN. This leads to heightened search accuracy. Machine learning with the reference image data ID_{ref} determines a weight coefficient.

As the machine learning, supervised leaning or unsupervised learning may be conducted. The unsupervised learning does not require teacher data and thus is preferable.

As shown in FIG. 10, the reference image data ID_{ref} includes a plurality of image data. FIG. 10 shows n image data (n is an integer greater than or equal to 2), each of which is denoted as data ID_{ref}(x) (x is an integer greater than or equal to 1 and less than or equal to n). For example, the data ID_{ref}(1) is data of a cross-sectional view of a laminate structure.

The first image analysis unit 121 optimizes the learning model LM by the machine learning with the n image data.

### [Step S32]

The reference image data ID_{ref} is input to the optimized learning model LM to generate reference image analysis data IAD_{ref}. Then, the reference image analysis data IAD_{ref} is output.

FIG. 8A shows an example where the generated reference image analysis data IAD_{ref} is output to the outside of the processing unit 103. For example, the first image analysis unit 121 can output the reference image analysis data IAD_{ref} to the memory unit 105 or the database 107. In some cases, the reference image analysis data IAD_{ref} may be directly supplied to a second image analysis unit 122 from the first image analysis unit 121.

In the example of FIG. 10, clustering (also referred to as cluster analysis) is performed in the first image analysis unit 121 and the clustering result is shown as the reference image analysis data IAD_{ref}. The reference image analysis data IAD_{ref} includes n pieces of coordinate information corresponding to the data ID_{ref}(1) to the data ID_{ref}(n).

In this manner, the reference analysis data can be generated.

Next, the processing for generating the analysis data is described with reference to FIG. 8B, FIG. 11, and FIGS. 12A and 12B. Desired intellectual property information can be searched for with the use of the reference analysis data generated beforehand.

### [Step S41]

First, image data ID is input to the learning model LM to generate first image analysis data IAD1.

For example, the image data ID is input to the processing unit 103 (the first image analysis unit 121 thereof) from the outside of the intellectual property information search system 100 through the input unit 101 and the transmission path 102.

FIG. 8B shows an example where the generated first image analysis data IAD1 is output to the outside of the processing unit 103. For example, the first image analysis unit 121 can output the first image analysis data IAD1 to the memory unit 105 or the database 107. In some cases, the first image analysis data IAD1 may be directly supplied to the second image analysis unit 122 from the first image analysis unit 121.

The first image analysis unit 121 preferably performs processing with the neural network NN. This leads to heightened search accuracy. The image data ID is input to the learning model LM that is optimized by the machine learning with the reference image data ID_{ref}, so that the first image analysis data IAD1 can be generated.

The image data ID in FIG. 12A is data of a cross-sectional view of a laminate structure, which does not include the top layer of the laminate structure of the data ID_{ref}(1).

FIG. 12A shows an example where clustering is performed in the first image analysis unit 121. The first image analysis data IAD1 includes coordinate information corresponding to the image data ID.

### [Step S42]

The first image analysis data IAD1 and the reference image analysis data IAD_{ref} are input to the second image analysis unit 122 and used to generate second image analysis data IAD2. Then, the second image analysis data IAD2 is output.

FIG. 8B shows an example where the generated second image analysis data IAD2 is output to the outside of the processing unit 103. For example, the second image analysis unit 122 can output the second image analysis data IAD2 to the memory unit 105 or the database 107.

The second image analysis unit 122 searches the n data included in the reference image analysis data IAD_{ref} for data similar to the first image analysis data IAD1.

As shown in FIG. 12B, the second image analysis unit 122 uses the coordinate information corresponding to the image data ID included in the first image analysis data IAD1 and the n pieces of coordinate information corresponding to the data ID_{ref}(1) to the data ID_{ref}(n) included in the reference image analysis data IAD_{ref}. For example, among the n coordinate points, a point closer to the point of the image data ID can be regarded as the point of data having higher similarity to the image data ID.

In the second image analysis unit 122, information showing the degree of similarity of each of the n data to the first image analysis data IAD1 can be obtained. With the obtained information, the data can be listed in the descending order of similarity as shown in FIG. 12B, for example. With the obtained information, only data whose similarity is higher than a predetermined value can be output.

In the example of FIG. 12B, the second image analysis data IAD2 shows that data that are the most and the second most similar to the first image analysis data IAD1 in the n data of the reference image analysis data IAD_{ref} are the data ID_{ref}(1) and the data ID_{ref}(n), respectively.

The second image analysis data IAD2 is part or all of the analysis data AD output from the processing unit 103. Note that the analysis data AD may be generated by combining the second image analysis data IAD2 with other data.

In this manner, data similar to the image data ID can be searched with the intellectual property information search system 100. In the above example, the data ID_{ref}(1) is the most similar to the image data ID.

### <2-3. Analysis of Text and Image>

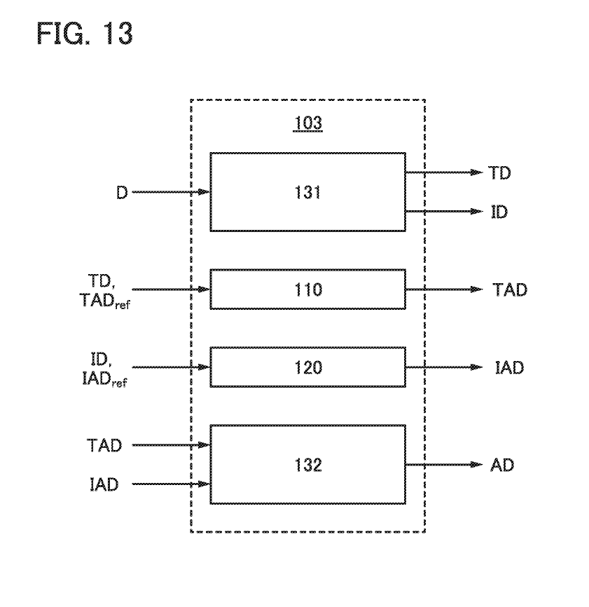

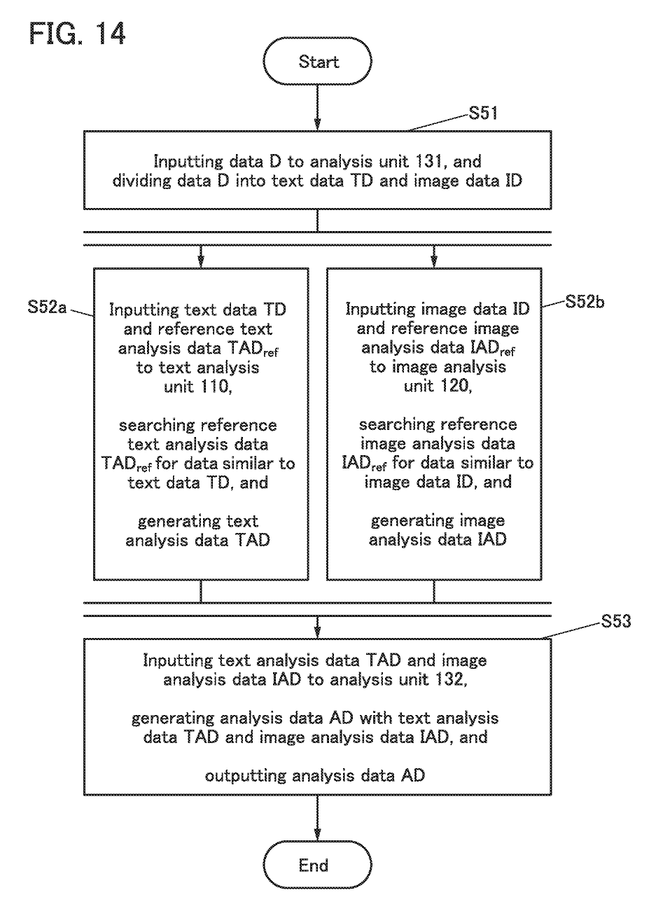

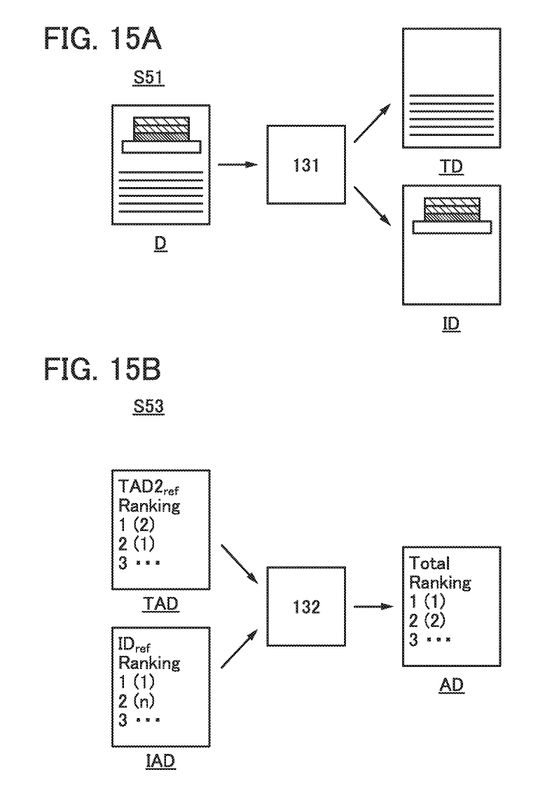

Search with both a text and an image in the intellectual property information search system 100 is described with reference to FIG. 13, FIG. 14, and FIGS. 15A and 15B. FIG. 13 shows a configuration of the processing unit 103 that is capable of search with both a text and an image. FIG. 14 is a flow chart of processing for generating analysis data. FIG. 15A is a schematic view illustrating the step S51 and FIG. 15B is a schematic view illustrating the step S53.

### [Step S51]

First, data D is input to an analysis unit 131 and divided into text data TD and image data ID.

For example, the data D is input to the processing unit 103 (the analysis unit 131 thereof) from the database 107 through the transmission path 102.

FIG. 13 shows an example where the generated text data TD and image data ID are output to the outside of the processing unit 103. For example, the analysis unit 131 can output the text data TD and the image data ID to the memory unit 105 or the database 107. In some cases, the text data TD may be directly supplied to a text analysis unit 110 from the analysis unit 131. Similarly, the image data ID may be directly supplied to an image analysis unit 120 from the analysis unit 131.

As shown in FIG. 15A, the data D including a text and an image is divided into the text data TD and the image data ID.

### [Step S52a]

Next, the text data TD and reference text analysis data TADref are input to the text analysis unit 110, and the reference text analysis data TADref is searched for data similar to the text data TD, so that text analysis data TAD is generated.

For a method for generating the text analysis data TAD, the above section <2-1. Text analysis> can be referred to. For example, the text analysis data TAD corresponds to the above third text analysis data TAD3.

### [Step S52b]

The image data ID and reference image analysis data IAD_{ref} are input to the image analysis unit 120, and the reference image analysis data IAD_{ref} is searched for data similar to the image data ID, so that image analysis data IAD is generated.

For a method for generating the image analysis data IAD, the above section <2-2. Image analysis> can be referred to. For example, the image analysis data IAD corresponds to the above second image analysis data IAD2.

Either the step S52a or the step S52b may be performed first, or both of them may be performed in parallel.

### [Step S53]

The text analysis data TAD and the image analysis data IAD are input to an analysis unit 132 and used to generate analysis data AD. Then, the analysis data AD is output.

The analysis unit 132 can output the text analysis data TAD and the image analysis data IAD as the analysis data AD without a change.

As shown in FIG. 15B, data may be ranked in the order of the similarity to the data D by summing the results of the text analysis data TAD and the image analysis data IAD to generate the analysis data AD.

In this manner, data similar to the data D including both the text and the image can be searched with the intellectual property information search system 100. This leads to more accurate search.

Note that after the data D is divided into the text data TD and the image data ID in the analysis unit 131, only one of the text data TD and the image data ID may be used for search.

### <2-4. Search for Two or More Kinds of Intellectual Property Information>

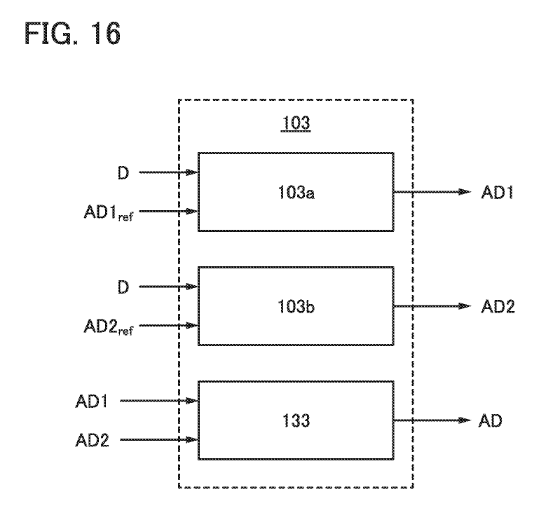

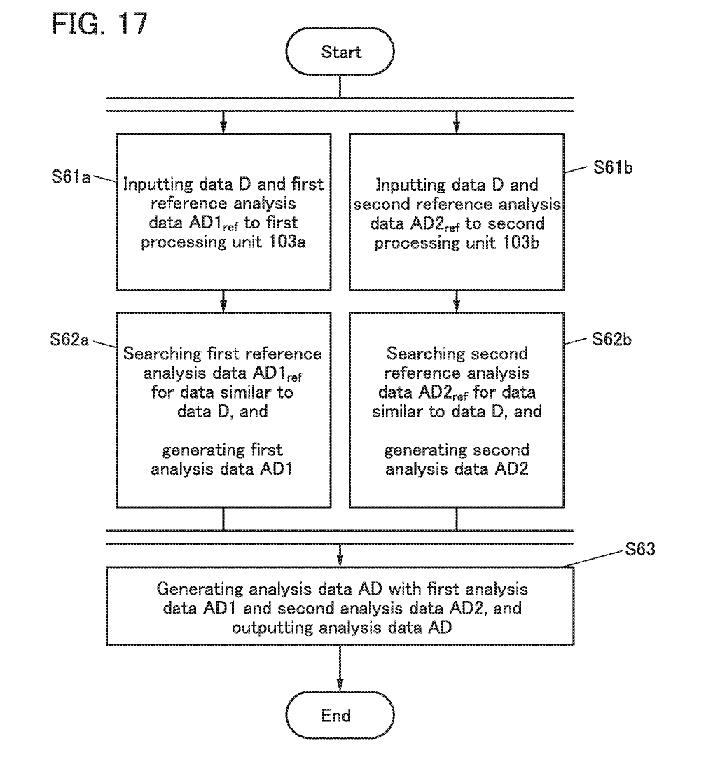

Searching two or more kinds of intellectual property information for one piece of intellectual property information with the use of the intellectual property information search system 100 is described with reference to FIG. 16 and FIG. 17. FIG. 16 shows a configuration of the processing unit 103 that is capable of searching two or more kinds of intellectual property information for one piece of intellectual property information. FIG. 17 is a flow chart of processing for generating analysis data.

### [Step S61a]

First, data D and first reference analysis data AD1_{ref} are input to a first processing unit 103a.

For example, the data D and the first reference analysis data AD1_{ref} are input to the processing unit 103 (the first processing unit 103a thereof) from the database 107 through the transmission path 102.

### [Step S62a]

Next, the first reference analysis data AD1_{ref} is searched for data similar to the data D to generate first analysis data AD1.

### [Step S61b]

The data D and second reference analysis data AD2_{ref} are input to a second processing unit 103b.

For example, the data D and the second reference analysis data AD2_{ref} are input to the processing unit 103 (the second processing unit 103b thereof) from the database 107 through the transmission path 102.

### [Step S62b]

Next, the second reference analysis data AD2_{ref} is searched for data similar to the data D to generate second analysis data AD2.

In the case where the data D includes only text data, the above section <2-1. Text analysis> can be referred to for a method for generating the first analysis data AD1 and the second analysis data AD2. In the case where the data D includes only image data, the above section <2-2. Image analysis> can be referred to for the generation method. In the case where the data D includes text data and image data, the above section <2-3. Analysis of text and image> can be referred to for the generation method.

Either the steps S61a to S62a or the steps S61b to S62b may be performed first, or both of them may be performed in parallel.

### [Step S63]

Next, the analysis data AD is generated with the use of the first analysis data AD1 and the second analysis data AD2 and then output.

An analysis unit 133 can output the first analysis data AD1 and the second analysis data AD2 as the analysis data AD without a change.

Alternatively, data may be ranked in the order of the similarity to the data D by summing the results of the first analysis data AD1 and the second analysis data AD2 to generate the analysis data AD.

For example, patent documents are used as the first reference analysis data AD1_{ref} and information on industrial products is used as the second reference analysis data AD2_{ref}, in which case both a patent document and information on an industrial product that are similar to the data D can be searched for.

In this way, two or more kinds of intellectual property information can be searched for one piece of intellectual property information with the use of the intellectual property information search system 100.

### <3. Example of Intellectual Property Information Search System>

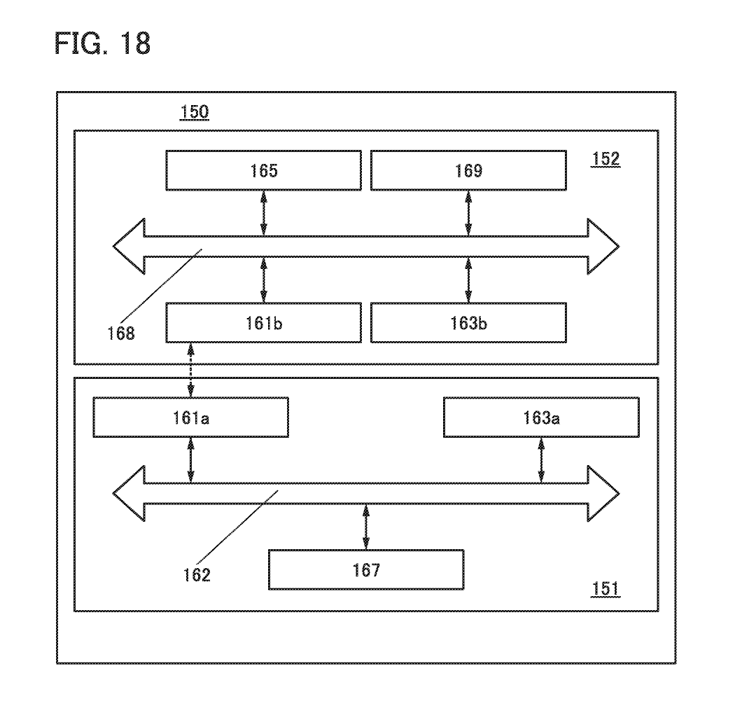

An intellectual property information search system 150 in FIG. 18 will be described.

FIG. 18 is a block diagram of the intellectual property information search system 150. The intellectual property information search system 150 includes a server 151 and a terminal 152 (such as a personal computer).

The server 151 includes a communication unit 161a, a transmission path 162, a processing unit 163a, and a database 167. The server 151 may further include a memory unit, an input/output unit, or the like (not illustrated in FIG. 18).

The terminal 152 includes a communication unit 161b, a transmission path 168, a processing unit 163b, a memory unit 165, and an input/output unit 169. The terminal 152 may further include a database or the like (not illustrated in FIG. 18).

Data including target information (first information) which is searched for is input to the server 151 from the terminal 152 by a user of the intellectual property information search system 150. The data is sent from the communication unit 161b to the communication unit 161a.

The data received by the communication unit 161a is stored in the database 167 or a memory unit (not illustrated) through the transmission path 162. In some cases, the data may be directly supplied to the processing unit 163a from the communication unit 161a.

The processings explained in the above section <2. Analysis> are performed in the processing unit 163a. These processings require high processing capacity, and thus are preferably performed in the processing unit 163a of the server 151.

The processing unit 163a generates analysis data. The analysis data is stored in the database 167 or the memory unit (not illustrated) through the transmission path 162. In some cases, the analysis data may be directly supplied to the communication unit 161a from the processing unit 163a. After that, the analysis data is output from the server 151 to the terminal 152. The data is sent from the communication unit 161a to the communication unit 161b.

### [Input/Output Unit 169]

Information is supplied to the input/output unit 169 from the outside of the intellectual property information search system 150. The input/output unit 169 is configured to supply information to the outside of the intellectual property information search system 150. Note that an input unit and an output unit may be separated from each other as in the intellectual property information search system 100.

### [Transmission Path 162 and Transmission Path 168]

The transmission path 162 and the transmission path 168 are each configured to convey information. The communication unit 161a, the processing unit 163a, and the database 167 can send and receive information through the transmission path 162. The communication unit 161b, the processing unit 163b, the memory unit 165, and the input/output unit 169 can send and receive information through the transmission path 168.

[Processing Unit 163a and Processing Unit 163b]

The processing unit 163a is configured to perform an operation, inference, or the like with the use of information supplied from the communication unit 161a, the database 167, or the like. The processing unit 163b is configured to perform an operation or the like with the use of information supplied from the communication unit 161b, the memory unit 165, the input/output unit 169, or the like. The description of the processing unit 103 can be referred to for the processing unit 163a and the processing unit 163b. In particular, the processing unit 163a can perform the processings described in the above section <2. Analysis>. The processing unit 163a preferably has higher processing capacity than the processing unit 163b.

### [Memory Unit 165]

The memory unit 165 is configured to store a program to be executed by the processing unit 163b. The memory unit 165 is also configured to store an operation result generated by the processing unit 163b, information input to the communication unit 161b, information input to the input/output unit 169, and the like.

### [Database 167]

The database 167 is configured to store reference analysis data. The database 167 may be configured to store an operation result generated by the processing unit 163a, information input to the communication unit 161a, and the like. The server 151 may include a memory unit in addition to the database 167, and the memory unit may be configured to store an operation result generated by the processing unit 163a, information input to the communication unit 161a, and the like.

[Communication Unit 161a and Communication Unit 161b]

The server 151 and the terminal 152 can send and receive information with the use of the communication unit 161a and the communication unit 161b. A hub, a router, a modem, or the like can be used for the communication unit 161a and the communication unit 161b. Information may be sent or received through wire communication or wireless communication (with radio waves, infrared light, or the like).

In this manner, the information search system of this embodiment can search plural pieces of information prepared beforehand for information similar to entered information. A keyword or a phrase for search is unnecessary and search with a text and an image is available; accordingly, differences in search accuracy among individuals can be reduced and information can be searched easily and accurately.

This embodiment can be combined with any of other embodiments as appropriate. In the case where a plurality of structure examples are described in one embodiment in this specification, some of the structure examples can be combined as appropriate.

### Embodiment 2

In this embodiment, a configuration example of a semiconductor device that can be used in a neural network is described.

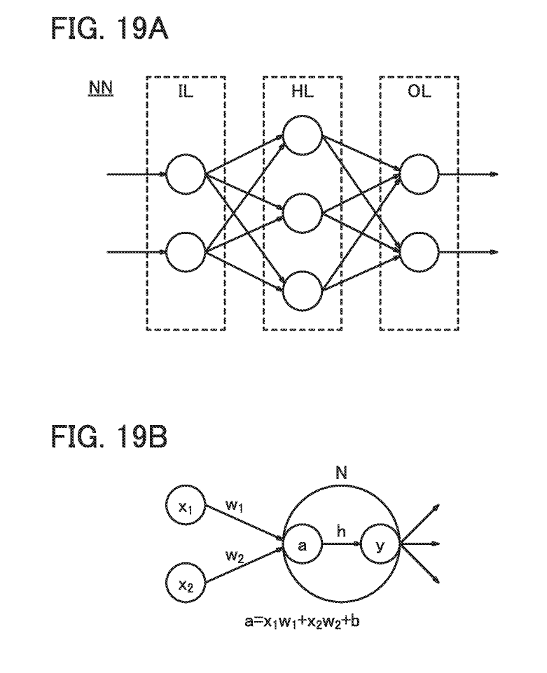

As illustrated in FIG. 19A, a neural network NN can be formed of an input layer IL, an output layer OL, and a middle layer (hidden layer) HL. The input layer IL, the output layer OL, and the middle layer HL each include one or more neurons (units). Note that the middle layer HL may be one layer or two or more layers. A neural network including two or more middle layers HL can also be referred to as a deep neural network (DNN), and learning using a deep neural network can also be referred to as deep learning.

Input data are input to neurons of the input layer IL, output signals of neurons in the previous layer or the subsequent layer are input to neurons of the middle layer HL, and output signals of neurons in the previous layer are input to neurons of the output layer OL. Note that each neuron may be connected to all the neurons in the previous and subsequent layers (full connection), or may be connected to some of the neurons.

FIG. 19B illustrates an example of an operation with the neurons. Here, a neuron N and two neurons in the previous layer which output signals to the neuron N are illustrated. An output x₁ of a neuron in the previous layer and an output x₂ of a neuron in the previous layer are input to the neuron N. Then, in the neuron N, a total sum x₁w₁±x₂w₂ of a multiplication result (x₁w₁) of the output x₁ and a weight w₁ and a multiplication result (x₂w₂) of the output x₂ and a weight w₂ is calculated, and then a bias b is added as necessary, so that the value a=x₁w₁+x₂w₂ b is obtained. Then, the value a is converted with an activation function h, and an output signal y=h(a) is output from the neuron N.

In this manner, the operation with the neurons includes the operation that sums the products of the outputs and the weights of the neurons in the previous layer, that is, the product-sum operation (x₁w₁+x₂w₂ in the above). This product-sum operation may be performed using a program on software or using hardware. In the case where the product-sum operation is performed by hardware, a product-sum arithmetic circuit can be used. A digital circuit or an analog circuit may be used as this product-sum arithmetic circuit. In the case where an analog circuit is used as the product-sum arithmetic circuit, the circuit scale of the product-sum arithmetic circuit can be reduced, or higher processing speed and lower power consumption can be achieved by reduced frequency of access to a memory.

The product-sum arithmetic circuit may include a transistor including silicon (such as single crystal silicon) in a channel formation region (hereinafter also referred to as a Si transistor) or a transistor including an oxide semiconductor in a channel formation region (hereinafter also referred to as an OS transistor). An OS transistor is particularly preferably used as a transistor included in a memory of the product-sum arithmetic circuit because of its extremely low off-state current. Note that the product-sum arithmetic circuit may include both a Si transistor and an OS transistor. A configuration example of a semiconductor device having a function of the product-sum arithmetic circuit is described below.

### <Configuration Example of Semiconductor Device>

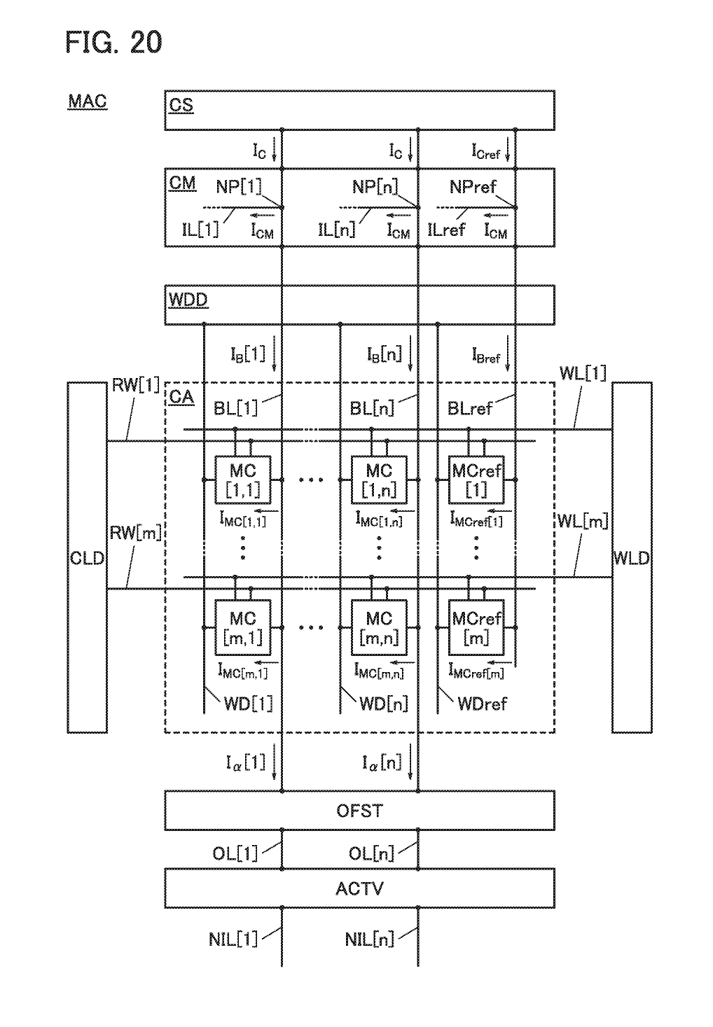

FIG. 20 illustrates a configuration example of a semiconductor device MAC configured to perform an operation of a neural network. The semiconductor device MAC is configured to perform a product-sum operation of first data corresponding to the strength (weight) of connection between the neurons and second data corresponding to input data. Note that the first data and the second data can each be analog data or multilevel digital data (discrete data). The semiconductor device MAC is also configured to convert data obtained by the product-sum operation with the activation function.

The semiconductor device MAC includes a cell array CA, a current source circuit CS, a current mirror circuit CM, a circuit WDD, a circuit WLD, a circuit CLD, an offset circuit OFST, and an activation function circuit ACTV.

The cell array CA includes a plurality of memory cells MC and a plurality of memory cells MCref. In the configuration example illustrated in FIG. 20, the cell array CA includes the memory cells MC in m rows and n columns (memory cells MC[1, 1] to MC[m, n]) and the m memory cells MCref (memory cells MCref[1] to MCref[m]) (m and n are integers greater than or equal to 1). The memory cells MC are configured to store the first data. In addition, the memory cells MCref are configured to store reference data used for the product-sum operation. Note that the reference data can be analog data or multilevel digital data.

The memory cell MC[i, j] is connected to a wiring WL[i], a wiring RW[i], a wiring WD[j], and a wiring BL[j] (i is an integer greater than or equal to 1 and less than or equal to m, and j is an integer greater than or equal to 1 and less than or equal to n). In addition, the memory cell MCref[i] is connected to the wiring WL[i], the wiring RW[i], a wiring WDref, and a wiring BLref. Here, a current flowing between the memory cell MC[i, j] and the wiring BL[j] is denoted by and a current flowing between the memory cell MCref[i] and the wiring BLref is denoted by I_{MCref[i]}.

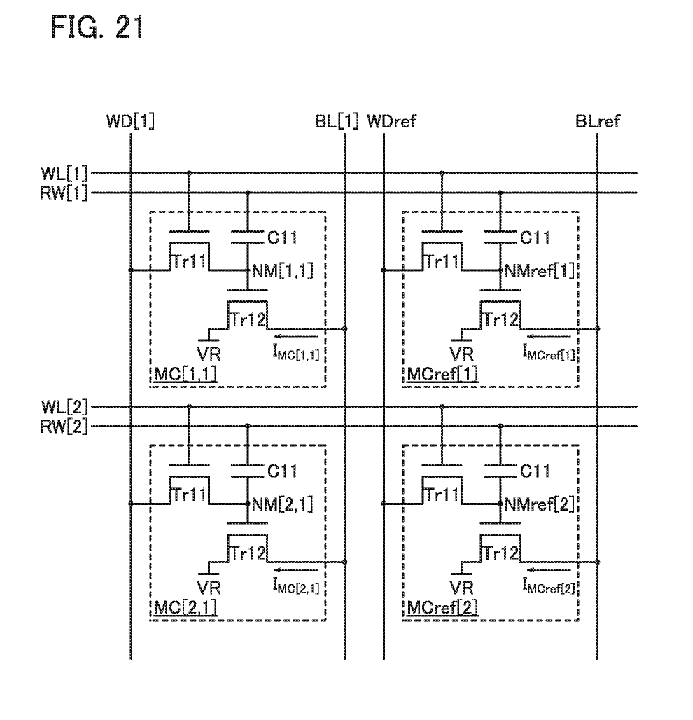

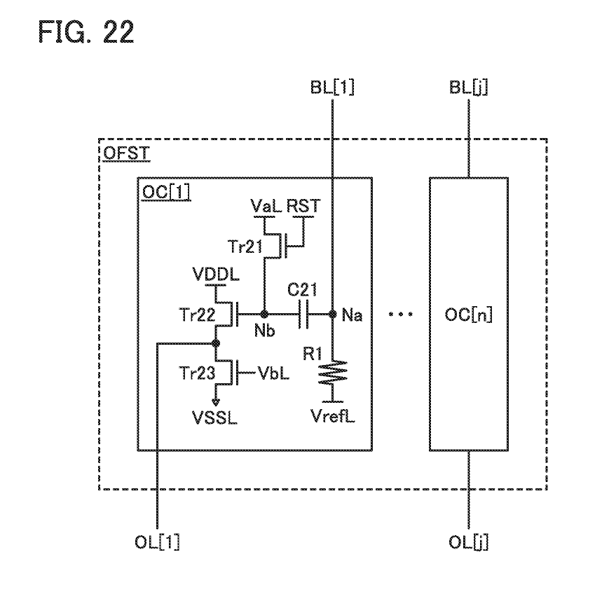

FIG. 21 illustrates a specific configuration example of the memory cell MC and the memory cell MCref. Although the memory cells MC[1, 1] and MC[2, 1] and the memory cells MCref[1] and MCref[2] are given as typical examples in FIG. 21, similar configurations can also be used for other memory cells MC and other memory cells MCref. The memory cells MC and the memory cells MCref each include a transistor Tr11, a transistor Tr12, and a capacitor C11. Here, the case where the transistors Tr11 and Tr12 are n-channel transistors is described.

In the memory cell MC, a gate of the transistor Tr11 is connected to the wiring WL, one of a source and a drain of the transistor Tr11 is connected to a gate of the transistor Tr12 and a first electrode of the capacitor C11, and the other of the source and the drain of the transistor Tr11 is connected to the wiring WD. One of a source and a drain of the transistor Tr12 is connected to the wiring BL, and the other of the source and the drain of the transistor Tr12 is connected to a wiring VR. A second electrode of the capacitor C11 is connected to the wiring RW. The wiring VR is configured to supply a predetermined potential. In this example, a low power source potential (e.g., a ground potential) is supplied from the wiring VR.

A node connected to the one of the source and the drain of the transistor Tr11, the gate of the transistor Tr12, and the first electrode of the capacitor C11 is referred to as a node NM. The nodes NM included in the memory cells MC[1, 1] and MC[2, 1] are referred to as nodes NM[1, 1] and NM[2, 1], respectively.

The memory cells MCref have a configuration similar to that of the memory cell MC. However, the memory cells MCref are connected to the wiring WDref instead of the wiring WD and connected to a wiring BLref instead of the wiring BL. Each of a node NMref[1] in the memory cell MCref[1] and a node NMref[2] in the memory cell MCref[2] refers to a node connected to the one of the source and the drain of the transistor Tr11, the gate of the transistor Tr12, and the first electrode of the capacitor C11.

The nodes NM and NMref function as holding nodes of the memory cells MC and MCref, respectively. The first data is held in the node NM and the reference data is held in the node NMref. Currents I_{MC[1, 1]} and I_{MC[2, 1]} from the wiring BL[1] flow to the transistors Tr12 of the memory cells MC[1, 1] and MC[2, 1], respectively. Currents I_{MCref[1, 1]} and I_{MCref[2]} from the wiring BLref flow to the transistors Tr12 of the memory cells MCref[1] and MCref[2], respectively.

Since the transistor Tr11 is configured to hold a potential of the node NM or the node NMref, the off-state current of the transistor Tr11 is preferably low. Thus, it is preferable to use an OS transistor, which has extremely low off-state current, as the transistor Tr11. This suppresses a change in the potential of the node NM or the node NMref, so that the operation accuracy can be increased. Furthermore, operations of refreshing the potential of the node NM or the node NMref can be performed with low frequency, which leads to a reduction in power consumption.

There is no particular limitation on the transistor Tr12, and for example, a Si transistor, an OS transistor, or the like can be used. In the case where an OS transistor is used as the transistor Tr12, the transistor Tr12 can be manufactured with the same manufacturing apparatus as the transistor Tr11, and accordingly manufacturing cost can be reduced. Note that the transistor Tr12 may be an n-channel transistor or a p-channel transistor.

The current source circuit CS is connected to the wirings BL[1] to BL[n] and the wiring BLref. The current source circuit CS is configured to supply currents to the wirings BL[1] to BL[n] and the wiring BLref Note that the value of the current supplied to the wirings BL[1] to BL[n] may be different from that of the current supplied to the wiring BLref. Here, the current supplied from the current source circuit CS to the wirings BL[1] to BL[n] is denoted by I_{C}, and the current supplied from the current source circuit CS to the wiring BLref is denoted by I_{Cref}.

The current mirror circuit CM includes wirings IL[1] to IL[n] and a wiring ILref. The wirings IL[1] to IL[n] are connected to the wirings BL[1] to BL[n], respectively, and the wiring ILref is connected to the wiring BLref. Here, a connection portion between the wirings IL[1] and BL[1] to a connection portion between the wirings IL[n] and BL[n] are referred to as nodes NP[1] to NP[n], respectively. Furthermore, a connection portion between the wiring ILref and the wiring BLref is referred to as a node NPref.

The current mirror circuit CM is configured to flow a current I_{CM} corresponding to the potential of the node NPref to the wiring ILref and flow this current I_{CM} also to the wirings IL[1] to IL[n]. In the example illustrated in FIG. 20, the current I_{CM} is discharged from the wiring BLref to the wiring ILref, and the current I_{CM} is discharged from the wirings BL[1] to BL[n] to the wirings IL[1] to IL[n]. Furthermore, currents flowing from the current mirror circuit CM to the cell array CA through the wirings BL[1] to BL[n] are denoted by I_{B}[1] to I_{B}[n], respectively. Furthermore, a current flowing from the current mirror circuit CM to the cell array CA through the wiring BLref is denoted by I_{Bref}.

The circuit WDD is connected to the wirings WD[1] to WD[n] and the wiring WDref. The circuit WDD is configured to supply a potential corresponding to the first data stored in the memory cells MC to the wirings WD[1] to WD[n]. The circuit WDD is also configured to supply a potential corresponding to the reference data stored in the memory cell MCref to the wiring WDref. The circuit WLD is connected to wirings WL[1] to WL[m]. The circuit WLD is configured to supply a signal for selecting the memory cell MC or MCref to which data is to be written to any of the wirings WL[1] to WL[m]. The circuit CLD is connected to the wirings RW[1] to RW[m]. The circuit CLD is configured to supply a potential corresponding to the second data to the wirings RW[1] to RW[m].

The offset circuit OFST is connected to the wirings BL[1] to BL[n] and wirings OL[1] to [n]. The offset circuit OFST is configured to detect the amount of currents flowing from the wirings BL[1] to BL[n] to the offset circuit OFST and/or the amount of a change in the currents flowing from the wirings BL[1] to BL[n] to the offset circuit OFST. The offset circuit OFST is also configured to output a detection result to the wirings OL[1] to OL[n]. Note that the offset circuit OFST may output a current corresponding to the detection result to the wiring OL, or may convert the current corresponding to the detection result into a voltage to output the voltage to the wiring OL. The currents flowing between the cell array CA and the offset circuit OFST are denoted by I_{α}[1] to I_{α}[n].

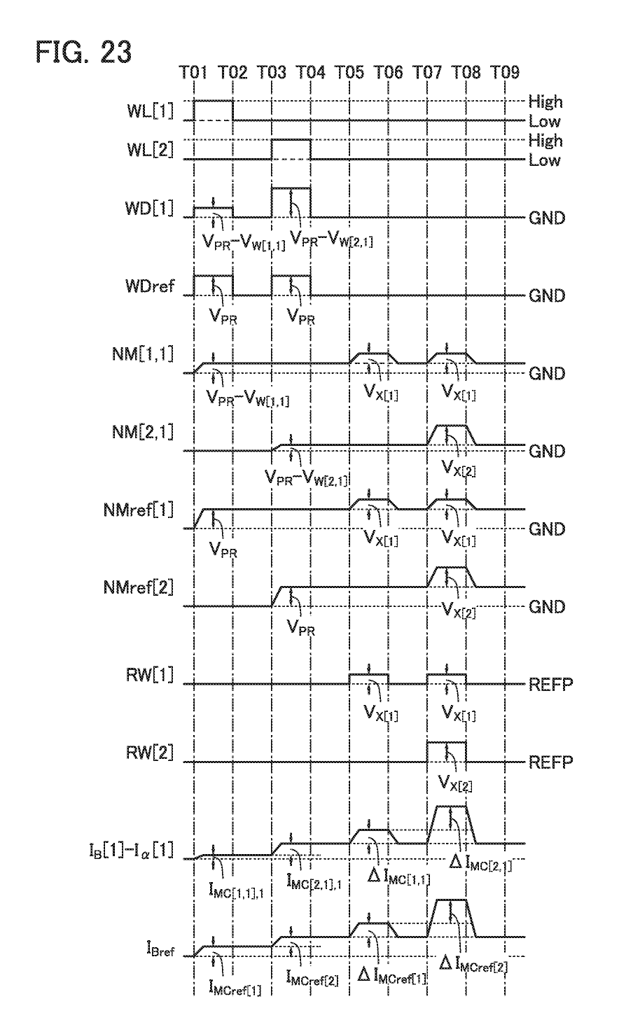

FIG. 22 illustrates a configuration example of the offset circuit OFST. The offset circuit OFST illustrated in FIG. 22 includes circuits OC[1] to OC[n]. The circuits OC[1] to OC[n] each include a transistor Tr21, a transistor Tr22, a transistor Tr23, a capacitor C21, and a resistor R1. Connection relations of the elements are as illustrated in FIG. 22. Note that a node connected to a first electrode of the capacitor C21 and a first terminal of the resistor R1 is referred to as a node Na. In addition, a node connected to a second electrode of the capacitor C21, one of a source and a drain of the transistor Tr21, and a gate of the transistor Tr22 is referred to as a node Nb.

A wiring VrefL is configured to supply a potential Vref, a wiring VaL is configured to supply a potential Va, and a wiring VbL is configured to supply a potential Vb. Furthermore, a wiring VDDL is configured to supply a potential VDD, and a wiring VSSL is configured to supply a potential VSS. Here, the case where the potential VDD is a high power source potential and the potential VSS is a low power source potential is described. A wiring RST is configured to supply a potential for controlling the conduction state of the transistor Tr21. The transistor Tr22, the transistor Tr23, the wiring VDDL, the wiring VSSL, and the wiring VbL form a source follower circuit.

Next, an operation example of the circuits OC[1] to OC[n] is described. Note that although an operation example of the circuit OC[1] is described here as a typical example, the circuits OC[2] to OC[n] can be operated in a manner similar to that of the circuit OC[1]. First, when a first current flows to the wiring BL[1], the potential of the node Na becomes a potential corresponding to the first current and the resistance value of the resistor R1. At this time, the transistor Tr21 is in an on state, and thus the potential Va is supplied to the node Nb. Then, the transistor Tr21 is turned off.

Next, when a second current flows to the wiring BL[1], the potential of the node Na becomes a potential corresponding to the second current and the resistance value of the resistor R1. At this time, since the transistor Tr21 is in an off state and the node Nb is in a floating state, the potential of the node Nb is changed owing to capacitive coupling, following the change in the potential of the node Na. Here, when the amount of change in the potential of the node Na is ΔV_{Na} and the capacitive coupling coefficient is 1, the potential of the node Nb is Va+ΔV_{Na}. In addition, when the threshold voltage of the transistor Tr22 is Vₜₕ, a potential of Va+ΔV_{Na}−Vₜₕ is output from the wiring OL[1]. Here, when Va=Vₜₕ, the potential ΔV_{Na} can be output from the wiring OL[1].

The potential ΔV_{Na} is determined by the amount of change from the first current to the second current, the resistor R1, and the potential Vref Here, since the resistor R1 and the potential Vref are known, the amount of change in the current flowing to the wiring BL can be found from the potential ΔV_{Na}.

A signal corresponding to the amount of current and/or the amount of change in the current detected by the offset circuit OFST as described above is input to the activation function circuit ACTV through the wirings OL[1] to OL[n].

The activation function circuit ACTV is connected to the wirings OL[1] to OL[n] and wirings NIL[1] to NIL[n]. The activation function circuit ACTV is configured to perform an operation for converting the signal input from the offset circuit OFST in accordance with the predefined activation function. As the activation function, for example, a sigmoid function, a tan h function, a softmax function, a ReLU function, a threshold function, or the like can be used. The signal converted by the activation function circuit ACTV is output as output data to the wirings NIL[1] to NIL[n].

### <Operation Example of Semiconductor Device>

With the above semiconductor device MAC, the product-sum operation of the first data and the second data can be performed. An operation example of the semiconductor device MAC at the time of performing the product-sum operation is described below.

FIG. 23 is a timing chart showing the operation example of the semiconductor device MAC. FIG. 23 shows changes in the potentials of the wirings WL[1], WL[2], WD[1], and WDref, the nodes NM[1, 1], NM[2, 1], NMref[1], and NMref[2], and the wirings RW[1] and RW[2] in FIG. 21 and changes in the values of the currents I_{B}[1]−I_{α}[1] and I_{Bref}. The current I_{B}[1]−1_{α}[1] corresponds to a total of the currents flowing from the wiring BL[1] to the memory cells MC[1, 1] and MC[2, 1].

Although an operation is described with a focus on the memory cells MC[1, 1], MC[2, 1], MCref[1], and MCref[2] illustrated in FIG. 21 as a typical example, the other memory cells MC and MCref can also be operated in a similar manner.

### [Storage of First Data]

First, during a period from Time T01 to Time T02, the potential of the wiring WL[1] becomes a high level, the potential of the wiring WD[1] becomes a potential greater than a ground potential (GND) by V_{PR}−d V_{W[1, 1]}, and the potential of the wiring WDref becomes a potential greater than the ground potential by V_{PR}. The potentials of the wirings RW[1] and RW[2] are reference potentials (REFP). Note that the potential V_{W[1, 1]} is the potential corresponding to the first data stored in the memory cell MC[1, 1]. The potential V_{PR} is the potential corresponding to the reference data. Thus, the transistors Tr11 included in the memory cells MC[1, 1] and MCref[1] are turned on, and the potentials of the nodes NM[1, 1] and NMref[1] become V_{PR}−V_{W[1, 1]} and V_{PR}, respectively.

In this case, a current I_{MC[1, 1], 0} flowing from the wiring BL[1] to the transistor Tr12 in the memory cell MC[1, 1] can be expressed by a formula shown below. Here, k is a constant determined by the channel length, the channel width, the mobility, the capacitance of a gate insulating film, and the like of the transistor Tr12. Furthermore, Vₜₕ is a threshold voltage of the transistor Tr12.

I_{MC[1, 1], 0}=k(V_{PR}−V_{W[1, 1]}−Vₜₕ)² (E1)

Furthermore, a current I_{MCref[1], 0} flowing from the wiring BLref to the transistor Tr12 in the memory cell MCref[1] can be expressed by a formula shown below.

I_{MCref[1], 0}=k(V_{PR}−Vₜₕ)² (E2)

Next, during a period from Time T02 to Time T03, the potential of the wiring WL[1] becomes a low level. Consequently, the transistors Tr11 included in the memory cells MC[1, 1] and MCref[1] are turned off, and the potentials of the nodes NM[1, 1] and NMref[1] are held.

As described above, an OS transistor is preferably used as the transistor Tr11. This can suppress the leakage current of the transistor Tr11, so that the potentials of the nodes NM[1, 1] and NMref[1] can be accurately held.

Next, during a period from Time T03 to Time T04, the potential of the wiring WL[2] becomes the high level, the potential of the wiring WD[1] becomes a potential greater than the ground potential by V_{PR}−V_{W[2, 1]}, and the potential of the wiring WDref becomes a potential greater than the ground potential by V_{PR}. Note that the potential V_{W[2, 1]} is a potential corresponding to the first data stored in the memory cell MC[2, 1]. Thus, the transistors Tr11 included in the memory cells MC[2, 1] and MCref[2] are turned on, and the potentials of the nodes NM[2, 1] and NMref[2] become V_{PR}−V_{W[2, 1]} and V_{PR}, respectively.

Here, a current I_{MC[2, 1], 0} flowing from the wiring BL[1] to the transistor Tr12 in the memory cell MC[2, 1] can be expressed by a formula shown below.

I_{MC[2, 1], 0}=k(V_{PR}−V_{W[2, 1]}−Vₜₕ)² (E3)

Furthermore, a current I_{MCref[2], 0} flowing from the wiring BLref to the transistor Tr12 in the memory cell MCref[2] can be expressed by a formula shown below.

I_{MCref[2], 0}=k(V_{PR}−Vₜₕ)² (E4)

Next, during a period from Time T04 to Time T05, the potential of the wiring WL[2] becomes the low level. Consequently, the transistors Tr11 included in the memory cells MC[2, 1] and MCref[2] are turned off, and the potentials of the nodes NM[2, 1] and NMref[2] are held.

Through the above operation, the first data is stored in the memory cells MC[1, 1] and MC[2, 1], and the reference data is stored in the memory cells MCref[1] and MCref[2].

Here, currents flowing to the wirings BL[1] and BLref during the period from Time T04 to Time T05 are considered. The current is supplied from the current source circuit CS to the wiring BLref. The current flowing through the wiring BLref is discharged to the current mirror circuit CM and the memory cells MCref[1] and MCref[2]. A formula shown below holds where I_{Cref} is the current supplied from the current source circuit CS to the wiring BLref and I_{CM, 0} is the current discharged from the wiring BLref to the current mirror circuit CM.

I_{Cref}−I_{CM, 0}=I_{MCref[1], 0}+I_{MCref[2], 0} (E5)

The current from the current source circuit CS is supplied to the wiring BL[1]. The current flowing through the wiring BL[1] is discharged to the current mirror circuit CM and the memory cells MC[1, 1] and MC[2, 1]. Furthermore, the current flows from the wiring BL[1] to the offset circuit OFST. A formula shown below holds where I_{C, 0} is the current supplied from the current source circuit CS to the wiring BL[1] and I_{α, 0} is the current flowing from the wiring BL[1] to the offset circuit OFST.

I_{C}−I_{CM, 0}=I_{MC[1, 1], 0}+I_{MC[2, 1], 0}+I_{α, 0} (E6)

### [Product-Sum Operation of First Data and Second Data]

Next, during a period from Time T05 to Time T06, the potential of the wiring RW[1] becomes a potential greater than the reference potential by V_{X[1]}. At this time, the potential V_{X[1]} is supplied to the capacitors C11 in the memory cells MC[1, 1] and MCref[1], so that the potentials of the gates of the transistors Tr12 increase owing to capacitive coupling. Note that the potential V_{X[1]} is the potential corresponding to the second data supplied to the memory cells MC[1, 1] and MCref[1].

The amount of change in the potential of the gate of the transistor Tr12 corresponds to the value obtained by multiplying the amount of change in the potential of the wiring RW by a capacitive coupling coefficient determined by the memory cell configuration. The capacitive coupling coefficient is calculated on the basis of the capacitance of the capacitor C11, the gate capacitance of the transistor Tr12, the parasitic capacitance, and the like. In the following description, for convenience, the amount of change in the potential of the wiring RW is equal to the amount of change in the potential of the gate of the transistor Tr12, that is, the capacitive coupling coefficient is set to 1. In practice, the potential Vx can be determined in consideration of the capacitive coupling coefficient.

When the potential V_{X[1]} is supplied to the capacitors C11 in the memory cells MC[1, 1] and MCref[1], the potentials of the nodes NM[1, 1] and NMref[1] each increase by V_{X[1]}.

Here, a current I_{MC[1, 1], 1} flowing from the wiring BL[1] to the transistor Tr12 in the memory cell MC[1, 1] during the period from Time T05 to Time T06 can be expressed by a formula shown below.

I_{MC[1, 1], 1}=k(V_{PR}−V_{W[1, 1]}+V_{X[1]}−Vₜₕ)² (E7)

Thus, when the potential V_{X[1]} is supplied to the wiring RW[1], the current flowing from the wiring BL[1] to the transistor Tr12 in the memory cell MC[1, 1] increases by ΔI_{MC[1, 1]}=I_{MC[1, 1], 1}−I_{MC[1, 1], 0}.

Here, a current I_{MCref[1], 1} flowing from the wiring BLref to the transistor Tr12 in the memory cell MCref[1] during the period from Time T05 to Time T06 can be expressed by a formula shown below.

I_{MCref[1], 1}=k(V_{PR}+V_{X[1]}−Vₜₕ)² (E8)

Thus, when the potential V_{X[1]} is supplied to the wiring RW[1], the current flowing from the wiring BLref to the transistor Tr12 in the memory cell MCref[1] increases by ΔI_{MCref[1]}=I_{MCref[1], 1}−I_{MCref[1], 0}.

Furthermore, currents flowing to the wirings BL[1] and BLref are considered. A current I_{Cref} is supplied from the current source circuit CS to the wiring BLref. The current flowing through the wiring BLref is discharged to the current mirror circuit CM and the memory cells MCref[1] and MCref[2]. A formula shown below holds where I_{CM, 1} is the current discharged from the wiring BLref to the current mirror circuit CM.

I_{Cref}−I_{CM},1=I_{MCref[1], 1}+I_{MCref[2], 0} (E9)

The current I_{C} from the current source circuit CS is supplied to the wiring BL[1]. The current flowing through the wiring BL[1] is discharged to the current mirror circuit CM and the memory cells MC[1, 1] and MC[2, 1]. Furthermore, the current flows from the wiring BL[1] to the offset circuit OFST. A formula shown below holds where I_{α, 1} is the current flowing from the wiring BL[1] to the offset circuit OFST.

I_{C}−I_{CM, 1}=I_{MC[1, 1], 1}+I_{MC[2, 1], 1}+I_{α, 1} (E10)

In addition, from the formulae (E1) to (E10), a difference between the current I_{α, 0} and the current I_{α, 1} (differential current ΔI_{α}) can be expressed by a formula shown below.

ΔI_{α}=I_{α, 1}−I_{α, 0}=2kV_{W[1, 1]}V_{X[1]} (E11)

Thus, the differential current ΔI_{α} is a value corresponding to the product of the potentials V_{W[1, 1]} and V_{X[1]}.

After that, during a period from Time T06 to Time T07, the potential of the wiring RW[1] becomes the ground potential, and the potentials of the nodes NM[1, 1] and NMref[1] become similar to the potentials thereof during the period from Time T04 to Time T05.

Next, during a period from Time T07 to Time T08, the potential of the wiring RW[1] becomes the potential greater than the reference potential by V_{X[1]}, and the potential of the wiring RW[2] becomes a potential greater than the reference potential by V_{X[2]}. Accordingly, the potential V_{X[1]} is supplied to the capacitors C11 in the memory cell MC[1, 1] and the memory cell MCref[1], and the potentials of the node NM[1, 1] and the node NMref[1] each increase by V_{X[1]} due to capacitive coupling. Furthermore, the potential V_{X[2]} is supplied to the capacitors C11 in the memory cell MC[2, 1] and the memory cell MCref[2], and the potentials of the node NM[2, 1] and the node NMref[2] each increase by V_{X[2]} due to capacitive coupling.

Here, the current I_{MC[2, 1], 1} flowing from the wiring BL[1] to the transistor Tr12 in the memory cell MC[2, 1] during the period from Time T07 to Time T08 can be expressed by a formula shown below.

I_{MC[2, 1], 1}=k(V_{PR}−V_{W[2, 1]}+V_{X[2]}−Vₜₕ)² (E12)

Thus, when the potential V_{X[2]} is supplied to the wiring RW[2], the current flowing from the wiring BL[1] to the transistor Tr12 in the memory cell MC[2, 1] increases by ΔI_{MC[2, 1}]=I_{MC[2, 1], 1}−I_{MC[2, 1], 0}.

Here, a current I_{MCref[2], 1} flowing from the wiring BLref to the transistor Tr12 in the memory cell MCref[2] during the period from Time T05 to Time T06 can be expressed by a formula shown below.

I_{MCref[2], 1}=k(V_{PR}+V_{X[2]}−Vₜₕ)² (E13)

Thus, when the potential V_{X[2]} is supplied to the wiring RW[2], the current flowing from the wiring BLref to the transistor Tr12 in the memory cell MCref[2] increases by ΔI_{MCref[2]}=I_{MCref[2], 1}−I_{MCref[2], 0}.

Furthermore, currents flowing to the wirings BL[1] and BLref are considered. The current I_{Cref} is supplied from the current source circuit CS to the wiring BLref. The current flowing through the wiring BLref is discharged to the current mirror circuit CM and the memory cells MCref[1] and MCref[2]. A formula shown below holds where I_{CM, 2} is the current discharged from the wiring BLref to the current mirror circuit CM.

I_{Cref}−I_{CM, 2}=I_{MCref[1], 1}+I_{MCref[2], 1} (E14)

The current I_{C} from the current source circuit CS is supplied to the wiring BL[1]. The current flowing through the wiring BL[1] is discharged to the current mirror circuit CM and the memory cells MC[1, 1] and MC[2, 1]. Furthermore, the current flows from the wiring BL[1] to the offset circuit OFST. A formula shown below holds where I_{α, 2} is the current flowing from the wiring BL[1] to the offset circuit OFST.

I_{C}−I_{CM, 2}=I_{MC[1, 1], 1}+I_{MC[2, 1], 1}+I_{α, 2} (E15)

In addition, from the formulae (E1) to (E8) and (E12) to (E15), a difference between the current I_{α, 0} and the current I_{α, 2} (differential current ΔI_{α}) can be expressed by a formula shown below.

ΔI_{α}=I_{α, 2}−I_{α, 0}=2k(V_{W[1, 1]}V_{X[1]}+V_{W[2, 1]}V_{X[2]}) (E16)

Thus, the differential current ΔI_{α} is a value corresponding to the sum of the product of the potentials V_{W[1, 1]} and V_{X[1]} and the product of the potentials V_{W[2, 1]} and V_{X[2]}.

After that, during a period from Time T08 to Time T09, the potentials of the wirings RW[1] and RW[2] become the ground potential, and the potentials of the nodes NM[1, 1], NM[2, 1], NMref[1], and NMref[2] become similar to the potentials thereof during the period from Time T04 to Time T05.

As represented by the formulae (E9) and (E16), the differential current ΔI_{α} input to the offset circuit OFST is a value corresponding to the sum of the products of the potentials V_{X} corresponding to the first data (weight) and the potentials V_{W} corresponding to the second data (input data). Thus, measurement of the differential current ΔI_{α} with the offset circuit OFST gives the result of the product-sum operation of the first data and the second data.

Note that although the memory cells MC[1, 1], MC[2, 1], MCref[1], and MCref[2] are focused in the above description, the number of the memory cells MC and MCref can be any number. In the case where the number m of rows of the memory cells MC and MCref is an arbitrary number, the differential current ΔI_{α} can be expressed by a formula shown below.

ΔI_{α}=2kΣᵢV_{W[i, 1]}V_{X[i]} (E17)

When the number n of columns of the memory cells MC and MCref is increased, the number of product-sum operations executed in parallel can be increased.

The product-sum operation of the first data and the second data can be performed using the semiconductor device MAC as described above. Note that the use of the configuration of the memory cells MC and MCref in FIG. 21 allows the product-sum arithmetic circuit to be formed of fewer transistors. Accordingly, the circuit scale of the semiconductor device MAC can be reduced.

In the case where the semiconductor device MAC is used for the operation in the neural network, the number m of rows of the memory cells MC can correspond to the number of pieces of input data supplied to one neuron and the number n of columns of the memory cells MC can correspond to the number of neurons. For example, the case where a product-sum operation using the semiconductor device MAC is performed in the middle layer HL in FIG. 19A is considered. In this case, the number m of rows of the memory cells MC can be set to the number of pieces of input data supplied from the input layer IL (the number of neurons in the input layer IL), and the number n of columns of the memory cells MC can be set to the number of neurons in the middle layer HL.

Note that there is no particular limitation on the configuration of the neural network for which the semiconductor device MAC is used. For example, the semiconductor device MAC can also be used for a convolutional neural network (CNN), a recurrent neural network (RNN), an autoencoder, a Boltzmann machine (including a restricted Boltzmann machine), or the like.

The product-sum operation of the neural network can be performed using the semiconductor device MAC as described above. Furthermore, the memory cells MC and MCref illustrated in FIG. 21 are used for the cell array CA, which can provide an integrated circuit with improved operation accuracy, lower power consumption, or a reduced circuit scale.

This embodiment can be combined with any of other embodiments as appropriate.

This application is based on Japanese Patent Application Serial No. 2017-107358 filed with Japan Patent Office on May 31, 2017, the entire contents of which are hereby incorporated by reference.

What is claimed is:

1. An information search system comprising a processing unit,
wherein:
first data and first reference analysis data are input to the processing unit,
the first data includes first information,
the first reference analysis data includes plural pieces of second information,
the processing unit is configured to search the first reference analysis data for data similar to the first data to generate second data and output the second data, and
the second data includes:
a piece of the second information similar to the first information; and
third information showing a degree of similarity of the piece of the second information to the first information.

2. The information search system according to claim 1,
wherein the first information is first intellectual property information, and
wherein the plural pieces of the second information are plural pieces of second intellectual property information.

3. The information search system according to claim 1,
wherein:
the first data includes text data,
the first reference analysis data includes reference text analysis data,
the processing unit includes a first text analysis unit, a second text analysis unit, and a third text analysis unit,
the first text analysis unit is configured to perform morphological analysis of the text data to generate first text analysis data,
the second text analysis unit is configured to calculate an appearance frequency of a word included in the text data with use of the first text analysis data to generate second text analysis data, and
the third text analysis unit is configured to compare the second text analysis data with the reference text analysis data to generate at least part of the second data.

4. The information search system according to claim 3,
wherein the second text analysis unit is configured to generate the second text analysis data with use of a neural network.

5. The information search system according to claim 3,
wherein the second text analysis unit includes a neural network circuit.

6. The information search system according to claim 1,
wherein:
the first data includes image data,
the first reference analysis data includes reference image analysis data,
the processing unit includes a first image analysis unit and a second image analysis unit,
the first image analysis unit is configured to input the image data into a learning model to generate first image analysis data, and
the second image analysis unit is configured to generate at least part of the second data with use of the first image analysis data and the reference image analysis data.

7. The information search system according to claim 6,
wherein the first image analysis unit is configured to generate the first image analysis data with use of a neural network.

8. The information search system according to claim 6,
wherein the first image analysis unit includes a neural network circuit.

9. The information search system according to claim 1,
wherein:
the first data includes text data and image data,
the first reference analysis data includes reference text analysis data and reference image analysis data,
the processing unit includes a text analysis unit, an image analysis unit, a first analysis unit, and a second analysis unit,
the first analysis unit is configured to divide the first data into the text data and the image data,
the text data and the reference text analysis data are input to the text analysis unit,
the text analysis unit is configured to search the reference text analysis data for data similar to the text data to generate text analysis data,
the image data and the reference image analysis data are input to the image analysis unit,
the image analysis unit is configured to search the reference image analysis data for data similar to the image data to generate image analysis data,
the text analysis data and the image analysis data are input to the second analysis unit, and
the second analysis unit is configured to generate at least part of the second data with use of the text analysis data and the image analysis data.

10. The information search system according to claim 1, further comprising a memory unit,
wherein the memory unit includes the first reference analysis data.

11. The information search system according to claim 2,
wherein:
the first reference analysis data includes patent document information,
the processing unit is configured to search the first reference analysis data for data similar to the first data to generate third data,
the processing unit is configured to output the third data, and
the third data includes:
third intellectual property information similar to the first intellectual property information; and
information showing a degree of similarity of the third intellectual property information to the first intellectual property information.

12. The information search system according to claim 2,
wherein:
the first reference analysis data includes industrial product information,
the processing unit is configured to search the first reference analysis data for data similar to the first data to generate third data,
the processing unit is configured to output the third data, and
the third data includes:
third intellectual property information similar to the first intellectual property information; and
information showing a degree of similarity of the third intellectual property information to the first intellectual property information.

13. The information search system according claim 2,
wherein:
the first data includes technical information on an industrial product and launch date information on the industrial product,
the second data includes information on a first patent document, and
a filing date of the first patent document is before a launch date of the industrial product.

14. The information search system according to claim 2,
wherein:
the first data includes information on a first patent document and filing date information on the first patent document,
the second data includes information on a second patent document,
a filing date of the second patent document is before a filing date of the first patent document, and
an applicant of the second patent document is different from an applicant of the first patent document.

15. The information search system according to claim 1, further comprising an electronic device and a server,
wherein:
the electronic device includes a first communication unit,
the server includes the processing unit and a second communication unit,
the first communication unit is configured to supply the first data to the server through at least one of wire communication and wireless communication,
the processing unit is configured to supply the second data to the second communication unit, and
the second communication unit is configured to supply the second data to the electronic device through at least one of wire communication and wireless communication.

16. The information search system according to claim 1,
wherein:
the processing unit includes a transistor, and
the transistor includes a metal oxide in a channel formation region.

17. The information search system according to claim 1,
wherein:
the processing unit includes a transistor, and
the transistor includes silicon in a channel formation region.

18. An information search method comprising:
inputting first data and first reference analysis data, the first data and the first reference analysis data including first information and plural pieces of second information, respectively;
searching the first reference analysis data for data similar to the first data;
generating second data including:
a piece of the second information similar to the first information; and
information showing a degree of similarity of the piece of the second information to the first information; and
outputting the second data.

19. The information search method according to claim 18,
wherein the first information is first intellectual property information, and
wherein the plural pieces of the second information are a plural pieces of second intellectual property information.

20. The information search method according to claim 18,
wherein:
text data included in the first data is subjected to morphological analysis to generate first text analysis data,
an appearance frequency of a word included in the text data is calculated with use of the first text analysis data to generate second text analysis data, and
the second text analysis data is compared with reference text analysis data included in the first reference analysis data to generate at least part of the second data.

21. The information search method according to claim 20,
wherein the second text analysis data is generated with use of a neural network.

22. The information search method according to claim 18,
wherein:
image data included in the first data is input to a learning model to generate first image analysis data, and
at least part of the second data is generated with use of the first image analysis data and reference image analysis data included in the first reference analysis data.

23. The information search method according to claim 22,
wherein the first image analysis data is generated with use of a neural network.

24. The information search method according to claim 18,
wherein:
the first data is divided into text data and image data,
reference text analysis data included in the first reference analysis data is searched for data similar to the text data to generate text analysis data,
reference image analysis data included in the first reference analysis data is searched for data similar to the image data to generate image analysis data, and
at least part of the second data is generated with use of the text analysis data and the image analysis data.

25. The information search method according to claim 19, further comprising:
inputting second reference analysis data including plural pieces of third intellectual property information;
searching the second reference analysis data for data similar to the first data;
generating third data including:
a piece of the third intellectual property information similar to the first intellectual property information; and
information showing a degree of similarity of the piece of the third intellectual property information to the first intellectual property information; and
outputting the third data.
